(19) United States
(12) Patent Application Publication
(10) Pub. No.: US 2016/0351310 A1
(43) Pub. Date: Dec. 1, 2016

(54) Low Temperature Superconductive and High Temperature Superconductive Amalgam Magnet

(71) Applicant: Christopher Mark Rey, Knoxville, TN (US)

(72) Inventor: Christopher Mark Rey, Knoxville, TN (US)

(21) Appl. No.: 14/999,585

(22) Filed: May 28, 2014

Related U.S. Application Data
(60) Provisional application No. 61/828,248, filed on May 29, 2013.

(51) Int. Cl. H01F 6/06; H01F 6/04; H01F 1/03; H01B 12/04

(52) U.S. Cl. CPC H01F 6/06; H01B 12/04; H01F 6/04; H01F 1/0306

(57) ABSTRACT

An exemplary superconducting amalgam magnet or a device enabled by superconducting magnets such as a motor, generator, transformer, FCL, MRI, NMR, accelerator magnet, fusion magnet, etc. fabricated with a conductor comprising of at least one or more low temperature superconductors and at least one or more high temperature superconductors. The high temperature superconductors are used in regions of the amalgam magnet where its current carrying capacity is superior to the low temperature superconductors and the low temperature superconductors are used in the remaining regions.

### STATEMENT REGARDING PRIOR DISCLOSURES BY THE INVENTOR

This application claims benefit of provisional patent application 61/828,248 submitted on May 29, 2013.

### CROSS REFERENCE TO RELATED APPLICATIONS

### U.S. Patent Documents

No. Issue/Publication date Author
U.S. Pat. No. 3,090,894 May 1963 Post et al.
U.S. Pat. No. 3,227,930 January 1966 Hnilicka, Jr.
U.S. Pat. No. 3,376,528 April 1968 Macy
U.S. Pat. No. 4,774,487 September 1988 Aubert
U.S. Pat. No. 4,794,358 December 1988 Steingroever et al.
U.S. Pat. No. 4,808,954 February 1989 Ito
U.S. Pat. No. 4,823,101 Apr. 1989 Aubert
U.S. Pat. No. 5,914,647 June 1999 Aized et al.
U.S. Pat. No. 7,015,779 March 2006 Markiewicz et al.
U.S. Pat. No. 7,068,134 June 2006 Olsen
U.S. Pat. No. 7,078,993 July 2006 Berg et al.
U.S. Pat. No. 7,215,230 May 2007 Niemann et al.
U.S. Pat. No. 7,609,139 October 2009 Bird et al.
U.S. Pat. No. 7,977,577 December 2009 Painter et al.
2003/0184427 October 2003 Gavrilin et al.

### STATEMENT REGARDING NEW MATTER

This substitute specification contains no new matter.

### STATEMENT REGARDING FEDERALLY SPONSORED RESEARCH OR DEVELOPMENT

Not applicable.

### BACKGROUND OF THE INVENTION

This disclosure relates to superconducting magnets and devices enabled by superconducting magnets. More particularly, this disclosure relates to a single amalgam superconducting magnet or an amalgam superconducting device that is comprised of two or more sub-sections of different types of superconducting wires and tapes. The amalgam superconducting magnet comprises at least one section made from a low temperature superconductors and another section made with high temperature superconductors. There are many useful devices that a superconducting amalgam magnet could be used in such as MRI, NMR, FCL, SMES, motors, generators, transformers, inductors, energy storage, fusion magnets, accelerator magnets, magnetic separation, inductor heaters, etc., if they could be made affordable and practical.

### DEFINITIONS

These terms are provided for clarity and brevity purposes, and are not to be taken as binding for claim construction.

Conductor: a single round or nearly round wire or multiple round wires or a single flat tape or multiple flat tapes, among other superconducting objects.
CICC: Cable-in-conduit-conductor

### FCL: Fault Current Limiter

### HTS: High Temperature Superconductor

Iₒₚ: Operating current
I_{c}: the critical current or the maximum amount of current that a superconductor can carry before transitioning from its superconducting state to its normal state at a specified temperature, magnitude of magnetic field, and direction of magnetic field.
Iₒₚ/I_{c}: The fraction of critical current

### LTS: Low Temperature Superconductor

Material: the material comprising a single round wire or multiple round wires or the material comprising a single flat tape or multiple flat tapes.
PIT: Powder-in-tube

### MRI: Magnetic Resonance Imaging

### NMR: Nuclear Magnetic Resonance

### R&D: Research & Development

### Re: Rare Earth

### SMES: Superconducting Magnetic Energy Storage

### RELATED ART

Common types of hybrid magnets typically consist of one or more separate magnet windings such as a resistive winding and a lower temperature superconducting magnet or a resistive winding, a low temperature superconducting winding, and a high temperature superconducting winding. Several examples of hybrid magnets include: U.S. Pat. No. 3,090,899 (Post et al.), U.S. Pat. No. 3,227,930 (Hnilica, Jr), U.S. Pat. No. 3,376,528 (Macy), U.S. Pat. No. 4,774,487 (Aubert), U.S. Pat. No. 7,609,139 (Bird et al) and U.S. Pat. No. 7,365,540 by Westphal. Most of the related art has concentrated on hybrid magnets consisting of conventional copper or copper alloy resistive magnets concentrically placed within the bore of larger diameter superconducting magnets. In a hybrid magnet, the magnet placed in the inner bore is known as an “insert” magnet and the magnet placed at the outer bore is known as an outsert magnet. The conventional copper magnets are often Bitter magnets such as those used in U.S. Pat. Nos. 3,090,899, 3,227,930, and 7,609,139. A technique by Gaverlin 2003/0184427 fabricates a transverse field magnet using conventional resistive Bitter plates. The techniques cited above are different than the single amalgam superconducting magnet fabricated with both HTS windings and LTS windings.

More recently, hybrid superconducting magnets consisting of conventional resistive, LTS magnets, and HTS inserts have been extensively studied. The primary difference between the related artwork and this disclosure is that the magnets that comprise traditional hybrid superconducting magnet are all separate distinct magnets. This disclosure is different in that both the HTS conductor and LTS conductor are wound into a single amalgam magnet.

A patent by Niemann et al. U.S. Pat. No. 7,215,230, concerns a method for calculating the travel of a band-shaped superconductor in a coil section of a high field magnet coil through a transition region towards or away from the coil section, wherein the coil section is wound onto a cylindrical coil body in the shape of a solenoid. This is different than the present disclosure which fabricates a superconducting magnet using an amalgam of LTS wire and HTS tape or fabricates MRI or NMR magnet with one or more sub-sections fabricated with LTS wire(s) and HTS tape(s). The U.S. Pat. No. 7,215,230 by Niemeann does not avoid the use HTS material in regions of high radial or perpendicular magnetic fields and general regions of low magnetic field. The U.S. Pat. No. 7,215,230 by Niemann does not select the use of HTS material in regions of high axial or parallel magnetic field and avoid the use of LTS material in these regions.

Examples of solder joints used in traditional hybrid superconducting magnets are demonstrated in the U.S. Pat. No. 7,977,577 by Painter et al.

### BRIEF SUMMARY OF THE INVENTION

For brevity and clarity purposes in this disclosure, the term “wire or multiple wires” is often used interchangeably with the term “tape or multiple tapes” to refer to either flat superconducting tapes, round superconducting wires, or other superconducting objects of differing cross-section.

Over the past several decades there has been a significant amount of R&D effort to develop practical, low cost high temperature superconductor (HTS) wires, tapes, and cables for devices such as: motors, generators, transformers, superconducting magnetic energy storage (SMES), fault-current-limiters (FCL), magnetic separators, induction heaters, MRI/NMR, fusion, accelerator magnets, detector magnets, etc. Many of the efforts to make high current carrying capacity HTS round wires (e.g. Bi-2212), flat tapes (e.g. Bi-2223 and ReBCO coated conductor) and cables at the lowest possible cost have met with some limited success. At the time of this writing, HTS tape such as Bi-2223 powder-in-tube tape and ReBCO coated conductor with flat rectangular shaped geometry is the vast majority of what is commercially available with a very limited amount of round Bi-2212 wire commercially available.

Most high temperature superconducting material exhibits strongly anisotropic behavior, where current carrying capacity is much higher when an applied magnetic field is applied in one crystallographic direction than when it is applied in another direction. For the cuprate superconductors (e.g. Re—Ba—Cu—O, Bi—Sr—Ca—Cu—O, etc.), the current carrying capacity is much higher when an external B-field is applied along the a-b planes of the crystallographic axis versus the c-axis of the crystal. While there are many anisotropic parameters in HTS wires and tapes, the anisotropic behavior of the present interest here is the superconductor's current carrying capacity in the presence of a background magnetic field. The background magnetic field is a vector quantity which has both a magnitude and direction relative to the transport current of the superconductor. The magnetic field vector can be broken down into components in three directions (or spatial coordinates), which for solenoids and toroids are best described in cylindrical coordinates. The cylindrical coordinates of the magnetic field are characterized by an axial or parallel component (Bz), a radial, transverse, or perpendicular component (Br), and a tangential, hoop, or angular component (theta or Bθ). In this disclosure, magnetic fields that impinge along the longitudinal axis of the conductor are Bz. Magnetic fields that impinge along the short axis of the conductor are Bθ, and magnetic field that impinge perpendicular to the axis of the conductor are Br.

The HTS wires or HTS tapes used in this disclosure are from either one of the cuprate family of materials or iron-pnictides or iron-chalcogenides. The cuprate family of materials include: Re—Ba—Cu—O, Bi—Sr—Ca—Cu—O, Tl—Ba—Ca—Cu—O, Hg—Ba—Ca—Cu—O, etc. The more recently discovered iron-pnictides family of materials include: La—Fe—As—O, Sm—Fe—As—O, La—Fe—As—Sb—O, Ba—K—Fe—As—O, Sr—K—Fe—As, Li—Fe—As, etc. or iron-chalcogenides such as Fe—Se, Fe—Te—Se, etc. These families of HTS materials (i.e. cuprates, iron-pnictides, and iron-chalcogenides) are highly anisotropic, in which the materials current carrying capacity depends both on the direction and magnitude of the impinging background magnetic field. At the time of this writing, the vast majority of commercially available HTS conductors are flat rectangular shaped tapes of the so-called second generation ReBCO coated conductor and the so-called first generation Bi-oxide powder-in-tube tapes (PIT). For these flat rectangular shaped ReBCO coated conductors and Bi-oxide PIT tapes, the current carrying capacity is highest (i.e. its critical current I_{c} is highest) when the impinging magnetic field is parallel to either the longitudinal or short tape face (Bz and Bθ) and lowest when the impinging magnetic field is perpendicular to the tape face (Br). This anisotropic behavior of I_{c} with respect to the impinging magnetic field is true over the entire operating temperature range of the HTS material.

Most HTS magnets or devices enabled by HTS magnets; however, suffer from the same limitation caused by the anisotropic behavior of the HTS material. That is, when a component of the background magnetic field impinges at an angle, other than parallel relative to the longitudinal axis Bz or the short axis Bθ of the HTS conductor, the current carrying capacity rapidly decreases. In many common magnet and device applications there usually exists a location in the magnet or coil where the magnetic field will impinge perpendicular (Br) to the face of the HTS conductor. Thus, for a HTS flat tape, when the background magnetic field component B_{z} or B_{θ} is parallel (or less than 6 to 8°) to the plane face of the superconducting tape (i.e. parallel to the longitudinal axis of the conductor), the current carrying capacity is significantly less degraded and remains quite high. Keeping the current carrying capacity high in a magnet or device is very important since it reduces the amount of superconducting tape which is required. Reducing the amount of HTS conductor in a magnet or device lowers the costs, weight, and shrinks the cross sectional area of the device. However, when the magnetic field component (Bᵣ) impinges perpendicular to the plane face of the HTS tape (or any angle greater than +/−6° to 8°), then the current carrying capacity rapidly diminishes. When the current carrying capacity decreases, more turns and hence more conductor is required to keep the number of ampere-turns constant. This correspondingly has the deleterious effect of increasing cost, weight, and size of the device. In most magnet applications, the conductor will experience a combination of both parallel magnetic fields (B_{z} and B_{θ}) and perpendicular magnetics fields (Bᵣ). Magnetic fields that impinge perpendicular to the plane face of the HTS tape are sometimes referred to as transverse magnetic fields.

Most practical low temperature superconducting wires such as NbTi, Nb₃Sn, Nb₃Al, and MgB₂ and chemically doped alloys thereof are isotropic or at least exhibit extremely small anisotropic behavior. In practical terms for the present discussion, an isotropic superconductor is one in which the materials current carrying capacity does not depend (or very weakly depends) upon the directional component of the magnetic field relative to the crystallographic axis of the superconductor, but instead only its magnitude of the magnetic field. The LTS wires used in certain embodiments are isotropic or very weakly anisotropic and come from the family of materials e.g. NbTi, Nb₃Sn, Nb₃Al, Mg—B, MgB₂, or chemically doped alloys thereof.

The upper critical field H_{c2} in high temperature superconductors is much higher than in low temperature superconductors. Therefore, one embodiment could be to create an entirely new type of amalgam superconducting magnet in which the amalgam magnet is sub-divided into sections containing either LTS conductor or HTS conductor, or a combination of both. The HTS conductor is utilized in regions of the superconducting amalgam magnet where it is better suited and the LTS conductor is utilized in regions where it is better suited than the HTS conductor. The conductor for the amalgam superconducting magnet can be either formed by electrically connecting two separate pieces of LTS wire and HTS tape in series or alternatively the amalgam superconducting magnet can made from an amalgam conductor comprising both LTS and HTS conductor electrically connected in parallel.

### BRIEF DESCRIPTION OF SEVERAL VIEWS OF THE DRAWING

FIG. 1a: is a 2-d cross-section of an LTS-HTS amalgam solenoid superconducting magnet forming one section with LTS conductor(s) and one section with HTS conductor(s).

FIG. 1b: is another view of a 2-d cross-section of an LTS-HTS amalgam solenoid g magnet showing some regions of high radial magnetic field (Br) and high axial magnetic field (Bz).

FIG. 2a: is an isometric view of cross-section on an LTS-HTS amalgam conductor fabricated from two separate piece lengths of LTS wire(s) and HTS tape(s). The LTS wire(s) and HTS tape(s) are electrically connected/bonded together. The LTS wire(s) is also electrically connected/bonded to a dummy non-superconducting wire and the HTS tape(s) is electrically connected/bonded to a non-superconducting tape.

FIG. 2b: is another isometric view of cross-section on an insulated LTS-HTS amalgam conductor fabricated from two separate piece lengths of LTS wire(s) and HTS tape(s) that are electrically connected/bonded together.

FIG. 2c: is another isometric view of cross-section on an insulated LTS-HTS amalgam conductor fabricated from two separate piece lengths of LTS wire(s) and HTS tape(s). There are no dummy, non-superconducting wires or tapes in this embodiment.

FIG. 3a: is an isometric view of a cross-section of an LTS-HTS amalgam cable-in-channel/tray conductor, showing multiple LTS wires.

FIG. 3b: is an isometric view of a cross-section of an LTS-HTS amalgam cable-in-channel/tray conductor, showing multiple HTS tapes.

FIG. 4: is a 2-d cross-section of an LTS-HTS amalgam “notched” solenoid magnet comprising one or more sections with LTS conductor(s) and one or more sections of HTS conductor(s).

FIG. 5: is a 2-d cross-section of an LTS-HTS amalgam “stepped” solenoid magnet comprising one or more sections with LTS conductor(s) and one or more sections of HTS conductor(s).

FIG. 6: is a 2-d cross-section of an LTS-HTS amalgam solenoid magnet comprising one or more sections with LTS conductor(s) and one or more sections of HTS conductor(s). Additional coil winding are placed at the ends of the solenoid and separated by a non-superconducting spacer.

### DETAILED DESCRIPTION OF THE INVENTION

### LTS-HTS Amalgam Superconducting Magnet

In one embodiment, a superconducting magnet or a device enabled by a superconducting magnet or magnets having a plurality of low temperature superconductors (LTS) and high temperature superconductors (HTS) all combined into a single amalgam superconducting magnet or electromagnetic device. In this embodiment, both the HTS conductors and the LTS conductors operate at the similar temperature; however, it is possible to provide separate coolant paths so that each operates at different temperatures. As a reminder, there are many different types of cross sections for these LTS and HTS conductors ranging from round or nearly round wires to flat tapes, ribbons or sheets. At the time of this writing, the most common cross section commercially available in HTS conductor is the flat tape, while the most common type of commercially available LTS conductor is round or nearly wound wire. Round HTS is commercially available but is far less common. Likewise, flat, rectangular, or square shape LTS conductor is also readily available.

In one embodiment, both the LTS wire and the HTS tape are electrically connected in series and powered with the same electrical source, although it is possible to power the HTS winding separately from the LTS windings.

In another embodiment, both the LTS wire and HTS tape are electrically connected in parallel into a single amalgam superconducting wire and powered with the same electrical source, so that the current can either flow in the LTS wire or the HTS tape or a combination of both.

In one embodiment, the current carrying capacity of the HTS conductor is adjusted by selecting the width, HTS layer thickness, and number of HTS tapes. Likewise, the current carrying capacity of the LTS wires is varied by selecting the diameter and number of LTS wires. In this embodiment, the number and width of HTS tapes is adjusted so that its maximum current carrying capacity (I_{c}) is approximately equal to that of the LTS wires I_{c} and both the HTS tapes and the LTS wires operate at relatively the same fraction of critical current at a given operating temperature and magnetic field, where the fraction of critical current is defined as Iₒₚ/I_{c}_{_}_{LTS}. Common fractions of critical current in superconducting magnets range from 0.4 to 0.8.

In another embodiment, the fraction of critical current of the LTS wires is substantially less (e.g. 0.1-0.6) than the fraction of critical current of the HTS tapes (Iₒₚ/Ic__{^{HTS}}), which typically ranges from 0.6-0.9. When Iₒₚ/I_{c}_{_}_{LTS}<<Iₒₚ/Ic__{^{HTS}}, this increases the temperature margin of the LTS wire which helps to prevent quenches and simultaneously reduces the amount of HTS conductor used in the LTS-HTS amalgam magnet, while increasing the amount of LTS conductor. This reduces the cost of the LTS-HTS amalgam superconducting magnet because at the time of this writing, LTS conductor is much less expensive than HTS conductor. Since the temperature margin of LTS wires is generally much lower than that of HTS tapes, it is beneficial to try to match the temperature margin of the LTS and HTS conductor to the extent that it is possible. The fraction of critical current of the LTS wire can be increased by several means including increased number of superconducting filaments, larger diameter superconducting filaments, or a combination of both.

In one embodiment, the HTS conductors are located in the higher magnetic field region of the magnet or device and the LTS conductors are located in the lower magnetic field regions. More specifically, in this embodiment, if the HTS are flat tapes they will occupy the portion of the magnet or electromagnetic device that experiences the highest magnetic field that impinges axial/parallel (Bz or Bθ)) to the flat face of the HTS tapes. Likewise in this embodiment, the HTS tapes do not occupy the regions which experience the highest magnetic fields that impinge perpendicular/radial (Br) to the flat face of the HTS tapes. In the regions where the perpendicular or radial component of the magnetic field is large, these regions are occupied by the isotropic (or weakly anisotropic) LTS wires. The generally isotropic nature of the LTS material does not favor any one particular magnetic field orientation or vector component of magnetic field. For isotropic LTS materials, it is only the magnitude of the magnetic field that determines the current carrying capacity of the superconductor. In regions where the axial or parallel magnetic field is lower, these sections of the winding are fabricated with LTS wire or wires. Regions where very low radial or perpendicular magnetic field exists can be occupied by either LTS wire or HTS tape. In these regions the lower cost conductor per unit length is used to fabricate the winding. At the time of this writing, low temperature superconductors have a lower cost per unit length than high temperature superconductors.

LTS-HTS Amalgam Superconducting MM

There are many useful devices that can be made from the LTS-HTS amalgam magnet. One such device is an LTS-HTS amalgam Mill. The LTS-HTS amalgam MRI is particularly advantageous at higher operating magnetic fields (>3 T) and/or higher operating temperatures (>6K). Specifically, if the LTS-HTS amalgam superconducting magnet were an Mill magnet comprising multiple sections with some sections containing LTS NbTi wire and other sections containing HTS ReBCO coated conductor tape, then specific criteria could be established to determine what sections of the MRI contain the LTS NbTi wire and what sections of the Mill contain HTS ReBCO coated conductor tape. To illustrate by example, if the LTS-HTS amalgam superconducting magnet were an whole-body Mill with: 1) a 7 T magnetic field at its central axis (B_{z}=7 T), 2) a 90 cm diameter bore, 3) a total length of 1.8 m, 4) comprised of six separate sections to improve magnetic field homogeneity, and 5) operating at a temperature of 4.2 K, the criteria used to wind the LTS-HTS amalgam magnet could be: a) all regions of the LTS-HTS amalgam magnet winding that experience a magnetic field either parallel (B_{z}) or perpendicular (Bᵣ) to the conductor axis with a magnitude less than 3 T are comprised of LTS NbTi wire, b) all regions of the LTS-HTS amalgam magnet winding that experience only parallel magnetic fields (B_{z}) greater than 7 T in magnitude are comprised of HTS ReBCO coated conductor, c) regions of the LTS-HTS amalgam magnet winding that experience a parallel magnetic field B_{z}>3 T but less than 7 T and have a perpendicular magnetic field Bᵣ less than 1 T are comprised of HTS ReBCO, and d) finally regions of the LTS-HTS amalgam magnet winding that experience a parallel magnetic field B_{z}>3 T but less than 7 T and have a perpendicular magnetic field Bᵣ greater than 1 T are comprised of LTS NbTi. This would result in an LTS-HTS amalgam superconducting 7 T MM coil that was comprised of ˜90% LTS NbTi wire and ˜10% HTS ReBCO tape. The advantage of the LTS-HTS amalgam magnet is that it would be lower in cost than either the all HTS Mill or the all LTS MM and operate with greater reliability and less susceptible to quenching. The reason that the LTS-HTS amalgam 7 T MRI is lower in cost that the all LTS 7 T MRI is not immediately obvious. Upon more careful examination and calculation of the conductor selection criteria, however, the all LTS 7 T MM would require LTS NbTi conductor operating in regions of the MRI where the magnitude of the magnetic field exceeded 7 T and depending upon the MRI design could as high as 9 T in a six segmented MRI coil. For LTS NbTi, 7 T to 9 T is a relatively high magnetic field compared to HTS ReBCO operating at the same temperature, which means this substantially lowers critical current I_{c} of the LTS NbTi wire. This means that to maintain same fraction of critical current (Iₒₚ/I_{c}_{_}_{LTS}), the operating current Iₒₚ would have to decrease, which would require more turns to maintain the same magnetic field, and hence more LTS NbTi wire. Thus, the LTS-HTS amalgam magnet with 90% LTS NbTi wire and ˜10% HTS ReBCO tape would be lower in cost, smaller in volume, and weigh less than the all LTS 7 T Mill magnet. Other high-field Mill LTS-HTS amalgam magnets would require varying amounts of LTS and HTS conductor. Using similar criteria described above, a 9 T MRI coil with six separate segments, with a 90-cm bore, 1.8 m length and operated at 4.2 K would require approximately 70% LTS NbTi wire and ˜30% HTS ReBCO tape.

The amount and placement of the HTS conductor and LTS conductor and number of subsections comprising each will be different for each application in which the LTS-HTS amalgam superconducting magnet is used.

Minimizing Conductor Costs for the LTS-HTS Amalgam Superconducting Magnet

The cost performance ratio of superconductors is defined as the cost per unit length divided by the critical current (I_{c}) at a specified operating condition and is typically measured in dollars-per-kiloamp-meter ($/kA-m). At the time of this writing, the cost performance ratio is lower for most commercial low temperature superconductors than high temperature superconductors under the same operating conditions. Therefore, to keep the total cost of the LTS-HTS amalgam superconducting magnet lower, the amount of LTS wire is maximized while the HTS tape amount is minimized. As seen in the high-field Mill magnet example above, it is advantageous to use the HTS conductor when the magnitudes of the magnetic field are high and impinging parallel to the axis of the HTS conductor and to specifically avoid their use when the magnetic fields are impinging perpendicular to the axis of the HTS conductor.

Each design such as a solenoid or toroid is different depending upon many different and often competing factors including: a) shape factor (length/diameter), b) operating temperature, c) magnetic field strength, c) homogeneity requirements, d) persistent mode requirements, e) thermal and electric stability, f) ac loss, g) quench protection, h) cryogenic cooling, and i) costs constraints, etc. Each LTS-HTS amalgam superconducting magnet must be designed appropriately taking into account each of these design factors in order to find the appropriate balance between the amounts of HTS conductor versus the amounts of LTS conductor. For example, in long solenoids with large shape factors, HTS conductor is used in the inner diameter towards the central mid-plane, where the magnitude of the magnetic field component is high and mostly parallel (Bz). Likewise, LTS conductor is used at the end regions where the perpendicular magnetic field (Br) is large and in the outer diameter where the magnitude of the magnetic field is small.

As the costs, performances, and engineering considerations of both LTS and HTS conductors continue to evolve over time, it may be necessary to adjust the relative amounts in each section of the LTS-HTS amalgam superconducting magnet.

Electrically Connecting Separate Lengths of LTS and HTS Together in Series

In one embodiment, the LTS conductor(s) of length (L1) and HTS conductor(s) length (L2) are separate. The two separate lengths are then electrically connected together in series via a splice joint to form a continuous piece of combined length of L1+L2. The splice joint is the overlap region of the LTS conductor and the HTS conductor, and where the current will transfer from the LTS conductor to the HTS conductor and vice versa. The splice joint or overlap regions can be made very long to minimize electrical resistance or shorter if electrical resistance is less of a concern, depending upon the application. The type of splice joint can be from one of the many splice joint configurations including: butt joints, lap joints, bridge joints, interleaved joints, praying hands joints among other electrical joint configurations. The electrical connection between the LTS and HTS conductors can be made using one of many techniques including: solder, cold welding, pressed contacts, or other electrical connection methods. To keep the cross sectional dimension of the wire consistent and remain low cost, dummy non-superconducting conductor (e.g. Copper or aluminum tape) of similar width and thickness as the HTS tape can be utilized. Likewise, dummy non-superconducting conductor (i.e. copper or aluminum wire) of similar diameter or rectangular dimension can be utilized in place of the LTS conductor. In one embodiment, the splice joints may be very long (several tens of meters) and could be made over multiple turns of the LTS-HTS amalgam magnet to keep the resistance associated with these joints very low. This will help insure that the LTS-HTS amalgam superconducting magnets have excellent temporal stability. Temporal stability of better than 0.1 PPM/hr is often required in MRI applications.

In another embodiment, the splice joint or overlap region of LTS conductor and HTS conductor is substantially shorter typically <10 cm. Dummy non-superconducting conductor may also be used to keep the conductor dimensions constant when transitioning from the LTS conductor length to the HTS conductor length.

Persistent Current Electrical Connections in an LTS-HTS Amalgam Superconducting Magnet

In one embodiment, persistent current joints are made by electrically connecting the LTS conductor to LTS conductor using cold welding, electro-discharge welding, fusion welding, soldering, among other persistent current joint fabrication methods. As example of a possible fabrication method of persistent current joint please see J. Leupold and Y. Iwasa, Cryogenics, p. 215, (1976), which is incorporated by reference in its entirety for purposes of enablement. In this embodiment, these persistent current type connections are made in the low magnetic field regions of the magnet or device whenever possible. It is advantageous to make the persistent current joints in the low magnetic field regions since these joints represent interruptions to the superconducting current flow and having them made in the high field regions further reduces their operating margin making them more susceptible to overheating or quenching. It is also possible to electrically connect the HTS tape to the HTS tape via a splice joint but these types of joints tend to have higher joint resistance and are far more difficult and expensive to be fabricated into persistent joints.

Single Continuous Piece Length of Amalgam LTS and HTS Conductor Electrically Connected in Parallel

In another embodiment, the LTS conductors are electrically connected in parallel to the HTS conductors to form a single amalgam LTS and HTS conductor of a single piece length. The electrical connection between the LTS wire and the HTS can be made by a variety of methods such as soldering, welding, conductive epoxy, contact pressure between the LTS conductor to the HTS conductor, or even through non-contact inductive coupling. The superconducting current path is therefore provided by both the LTS conductor(s) and the HTS conductor(s). The relative amount of current distributed between the LTS wires and HTS tapes will vary depending upon the operating temperature, magnetic field, transport current, strain, and index value of the LTS and HTS material.

To keep the cross sectional dimension of the amalgam superconducting wire consistent and remain low cost, dummy non-superconducting tape such as copper, copper alloy, stainless steel, aluminum, brass, etc. of similar width and thickness as the HTS tape can be utilized in regions of the magnet where the HTS tape(s) are less beneficial. Likewise, dummy non-superconducting wire of similar diameter or rectangular dimension can be utilized in place of the LTS conductor in regions of the amalgam superconducting magnet where LTS wire(s) are less beneficial.

Superconducting Conductors (Wires or Tapes)

In one embodiment, the HTS conductors are generally flat planar tape or multiple tapes comprising Re—Ba—Cu—O, where Re is defined as rare-earth. In another embodiment, they are round HTS wire or wires such as Bi-2212 or round Re—Ba—Cu—O deposited on fibers or filaments. In yet another embodiment, the HTS material is neither round nor planar but consisting of multi-sided polygon such as the single crystal faceted substrate.

In another embodiment, the HTS conductors are comprised of materials from the iron-pnictides or the iron-chalcogenides comprising Fe—Se, Fe—Se—Te, etc.

In one embodiment, the LTS conductors are generally round wires or flattened wires with rounded edges. In another embodiment, the LTS material is a flat planar rectangular shaped tape.

Although the term tape or tapes is used predominantly in the description of the HTS conductor in this disclosure, the HTS conductor can be come in other cross-sectional shapes such hexagonal, square, rectangular, polygonal, etc. The HTS conductor can either be a mono-filament or multi-filamentary conductor. Likewise, the term wire or wires is used predominantly in the description of the LTS conductor it too can come in a variety of shapes, dimension, or size and can be mono-filament or multi-filamentary conductor. The advantage of mono-filament conductors (either LTS or HTS) is that they tend to carry more current per cross sectional area and are in general lower in cost, however, they are often much less flexible than multi-filament conductors and much more susceptible to damage during the winding and fabrication process.

Notched LTS-HTS Amalgam Superconducting Coil

In one embodiment, additional superconducting windings are provided at the ends of the main body of the LTS-HTS amalgam solenoid or toroid. The additional superconducting windings could be comprised of LTS conductor, HTS conductor, or LTS-HTS amalgam conductor. In one embodiment, the additional superconducting winds are powered with the same power sources as the main body of the LTS-HTS amalgam magnet, although these additional windings could be powered by a separate source from the main body of the LTS-HTS amalgam magnet.

In one embodiment, these additional superconducting windings are wound in the opposite direction of the windings of the main body of the LTS-HTS amalgam magnet. In another embodiment, these additional superconducting windings are wound in the same direction as the windings of the main body of the LTS-HTS amalgam magnet.

Depending upon the direction in which they are wound relative to the main body of the LTS-HTS amalgam magnet, winding additional conductor at the ends of a solenoid or toroid magnet can: a) reduce the stray or fringe magnetic field, b) provide a more homogenous and uniform magnetic field at the end regions and/or c) reduce the radial component (Br) of the magnetic field. This is known as a “notched” solenoid. The advantage of reducing the radial component of the magnetic field (Br) at the end regions in this embodiment allows the use of more isotropic LTS wire relative to the anisotropic HTS tape which lowers the overall cost of the LTS-HTS amalgam device.

In this embodiment, it is preferred to use LTS conductor for the additional superconducting windings added at the ends of the solenoid or toroid, since they reside in the lower magnetic field region and typically are less expensive per unit length than HTS conductor, although these additional windings could also be comprise of HTS conductor, or LTS-HTS amalgam conductor. The notched LTS-HTS amalgam superconducting coil must be properly designed so that the current carrying capacity is maximized in the sub-sections comprising of the isotropic LTS wire or wires and the sub-sections comprising the HTS tape or tapes. The amount and placement of the HTS conductor and LTS conductor and number of subsections comprising each will be different for each application in which the amalgam superconducting magnet is used. The general description of superconducting notched coils can be found in M. Wilson, Superconducting Magnets, Clarendon Press, Oxford: 1983, which is incorporated by reference in its entirety for the purposes of enablement.

Double Sided Coatings for the LTS-HTS Amalgam Superconductor

In one embodiment, the current carrying capacity of the HTS tapes may be further increased by the use of double sided coatings on the HTS multi-layer tapes. For the second generation ReBCO coated conductors, as the technology improves thicker superconductor coatings further enhance the current carrying capacity.

Magnetic Core or Magnetic Return Flux Path for the LTS-HTS Amalgam Superconducting Magnet

In one embodiment, an LTS-HTS amalgam electromagnet is comprised with non-superconducting magnetic or ferromagnetic material, LTS windings, and HTS windings. The LTS and HTS windings can provide the magneto-motive force that moves the magnetic flux around the magnetic circuit. The inclusion of ferromagnetic or magnetic material in the magnetic circuit such as: iron, nickel, cobalt, steel, or alloys thereof are used to provide an iron core or a return path for the magnetic flux. The use of magnetic material in the magnetic circuit lowers the magnetic reluctance and thereby reduces the amount of the magneto-motive force required and hence reduces the amount of ampere turns. The use of magnetic material also can lead to other performance improvements such as larger magnetic force. Magnetic pole tips and rings may also be used to further shape and refine the magnetic field. The advantages and uses of magnetic material in magnets and electrical circuits can be found in references such as: M. Nayfeh and M. Brussel, Electricity and Magnetism, John Wiley & Sons, New York: 1985 which is incorporated by reference in its entirety for the purposes of enablement.

Additional Windings or Trim Coils for the LTS-HTS Amalgam Superconducting Magnet

In some superconducting magnets, it can be useful to provide additional conductor windings at the end regions of the superconducting magnet that are separated by a non-superconducting spacer. These additional windings are sometimes referred to as trim coils or passive magnetic field cancellation coils. The additional windings can be comprised of either LTS conductor, HTS conductor, or an amalgam LTS-HTS conductor. The additional conductor windings can be wound either in the same direction (i.e. clockwise sense) as the main coil or in the opposite direction (i.e. counter-clockwise sense). These additional coils can be electrically connected in series with the main coil and powered with the same current source as the main coil or they can be completely separate windings that are independently powered with a different power source than the main winding. These additional conductor windings provide many useful functions including active and passive cancellation of the stray magnetic field thereby reducing the magnetic signature of the superconducting amalgam device. The additional windings can also be used to reduce the radial or perpendicular magnetic field Br at the end regions of the superconducting amalgam magnet.

In one embodiment, additional superconducting windings are provided at the ends of the main body of the solenoid or toroid coil. These additional windings at the ends of the magnet are separated by a non-superconducting spacer from the main body of the amalgam superconducting magnet. The axial height and radial thickness of the non-superconducting spacer must be properly designed so as to maximize: a) the current carrying capacity in the anisotropic HTS tape or tapes and b) the current carrying capacity in the isotropic LTS wire or wires. The spacer material can either be electrically conducting such as copper or aluminum, electrically resistive such as stainless steel, brass, bronze, copper or aluminum alloys, or electrically insulating such as fiber re-enforced plastic, thermoset, glass-cloth impregnated with epoxy, etc. In one embodiment, the additional windings are electrically connected in series with the main body winding. In another embodiment, the additional windings at the end of the coil are not electrically connected with the main coil but instead separately powered by an independent current source other than the power source of the main body windings. When the additional windings at the end of the main body windings are independently powered, they are sometimes referred to as trim coils.

In one embodiment, additional windings are placed at the ends of a solenoid or toroid and are separated by a spacer from the main body of the solenoid or toroid. In this embodiment, if the windings are wound in the same direction or clockwise sense as the windings in the main body the this will: a) reduce the stray magnetic field, b) provide a more homogenous and uniform magnetic field at the end regions and c) reduces the radial component of the magnetic field. In one embodiment, the LTS-HTS amalgam superconducting magnet design utilizes the LTS wire and HTS tape so as to maximize their respective current carrying capacities and minimize costs. In one embodiment the isotropic LTS wires will be placed in regions of high radial or perpendicular magnetic fields and the highly anisotropic HTS tapes will be placed in the regions of high axial or parallel magnetic fields. In one embodiment, the LTS wires are placed in the low magnetic field regions to help minimize conductor costs. The dimensions (width, thickness) of the spacers separating the main body from the additional windings at each end needs to be optimized for each different application. Trim coils can also be used in conjunction with notched coils to further optimize the application and help lower conductor costs.

In another embodiment, additional windings are placed at the ends of the solenoid or toroid and they are separated by a spacer from the main body of the solenoid or toroid, but in this embodiment the additional windings are wound in the opposite direction or opposite clockwise sense as the main windings. These additional windings can be separately powered although it is preferred in they are connected in series with the windings from the main body and powered from the same source. These additional windings will help reduce the stray or fringe magnetic field at the ends of the solenoid or toroid. This technique is sometimes referred to as passive shielding.

The amount and placement of the HTS conductor and LTS conductor and number of subsections comprising each can be different for each application in which the amalgam superconducting magnet is used.

Cooling the LTS-HTS Amalgam Superconducting Magnet

In this disclosure, the term cryogenic “fluid” can apply to many aspects of a materials phase diagram including single phase liquids, single phase gases, two-phase gas-liquid mixtures, single phase super-critical fluids, etc. see for example, J. Wilks, The Properties of Liquid and Solid Helium. Oxford: Clarendon Press (1967) ISBN 0-19-851245-7, which is incorporated by reference in its entirety for enablement.

In one embodiment, the LTS-HTS amalgam superconducting magnet is cooled by submersion into a cold cryogenic fluid such as liquid helium, liquid hydrogen, liquid neon, etc. In this embodiment, both the LTS conductor and the HTS conductor operate at similar temperatures. In this embodiment, cooling channels could be placed between some of the windings in the LTS-HTS amalgam magnet both in the radial direction and the axial direction to promote better heat removal. The number, location, and size of the cooling channels should be optimized for the given application.

In another embodiment, the LTS-HTS amalgam superconducting magnet is cooled by thermal conduction using a cryogenic refrigerator also known as a cryocooler. In this embodiment, the LTS conductor and HTS conductor could operate at different temperatures although it is more convenient if the HTS and LTS conductors operate at similar temperatures. In a conduction cooled LTS-HTS amalgam superconducting magnet, highly thermally conductive non-superconducting materials such as Cu, Ag, Au, or Al or alloys thereof are placed in intimate thermal contact with LTS and HTS conductor. These highly thermally conductive materials that are in intimate thermal contact with the LTS and HTS conductor are connected back to the cryocooler or multiple cryocoolers. The cryocooler is used to initially cool the LTS-HTS amalgam magnet and subsequently to help maintain its temperature during operation. The amount and placement of the non-superconducting material should be optimized for the given application.

In another embodiment, the LTS-HTS amalgam magnet is cooled with a combination a mechanical cryogenic refrigerator or cryocooler and a liquid or solid cryogen such as liquid or solid nitrogen, liquid or solid hydrogen, liquid or solid air, liquid or solid oxygen, liquid or solid neon, etc. The advantages of a liquid or solid cryogen combined with a cryocooler are that the liquid or solid cryogenic provides a thermal storage of energy in the event of failure of the mechanical cryocooler, while keeping the amount/volume of stored liquid or solid cryogen to a minimum. For example, in an MRI, NMR, FCL, or SMES application the electrical power to the facility hosting the superconducting device could go out or alternatively the mechanical cryocooler may fail or need routine maintenance. The use of a liquid or solid cryogen allows the LTS-HTS amalgam device to remain cold and operational while the power is restored or the cryocooler is returned to service. Liquid or solid hydrogen would be particularly advantageous in an LTS-HTS amalgam magnet because of its extremely high heat capacity and latent heat of fusion as it is transitioning from its solid state to its slush/liquid state. The volume or mass of the solid or liquid cryogen (e.g. solid/liquid hydrogen or helium) is selected based upon the operational heat load and the time required to “ride-through” the outage. Longer ride through times require more stored cryogen, shorter ride-through times require less stored cryogen.

In another embodiment, the HTS conductor and the LTS conductor are contained within a conduit or sheath. This type of conductor is known as a cable-in-conduit-conductor (CICC). The conduit provides a high pressure hermetic boundary. The CICC is internally cooled by convective heat transfer using forced flow cryogenic fluid such as supercritical helium or supercritical hydrogen through the conduit. There are several advantages of CICC superconducting magnets such as: high heat capacity and stability against quenching, the external conduit provides a support structure against the hoop forces during electromagnetic energization, the conduit wall provides a simple and convenient place to locate the electrical insulation, the conduit provides a hermetic pressure boundary to contain the high pressure cryogenic cooling fluid. The pressure drop and flow rate of the forced flowed cryogenic fluid is selected based upon the operating conditions of the device.

Insulation for the LTS-HTS Amalgam Superconducting Magnet

There is a need to electrically insulate the LTS and HTS conductor windings in an LTS-HTS amalgam magnet. There are many methods in which the electrical insulation can be applied to the LTS, HTS, and/or LTS-HTS amalgam conductors including: spiral wrapping with overlap, butt-wrapping with no overlap, co-winding, covering with heat shrinkable tubing, extrusion, spray coatings, dip coatings, spray coating, dip coating, plasma flame spray coating, and other insulating methods. Combinations of these methods may also be used.

In one embodiment, the windings in the LTS-HTS amalgam superconducting magnet are first spirally wrapped, butt-wrapped, or extruded insulation and then subsequently vacuum pressure impregnated (VPI) with epoxy resin. It is important to use an epoxy resin that is cryogenically compatible so that it does not crack upon repeated thermal cycling.

There are many types of cryogenically compatible insulations including: poly(4,4′-oxydiphenylene-pyromellitimide) sold under the trademark Kapton, polytetrafluoroethylene (PTFE), sold under the trademark Teflon, s-glass, e-glass, epoxy, flame-resistant meta-aramid sold under the trademark nomex by DuPont, polyvinyl form resin, polypropylene laminated paper (PPLP), cellulose also sold under the trademark Kraft™ paper, polyolefin sold under the trademark Cryoflex™, modified polyvinyl acetyl resin sold under the trademark Formvar™, and other insulating materials.

In another embodiment, the conductor for the LTS-HTS amalgam superconducting magnet is left bare without electrical insulation; however, there is a gap or spacing between adjacent conductors in both the radial and axial directions. In this embodiment, a cryogenic fluid such as liquid or solid helium, liquid or solid nitrogen, liquid or solid hydrogen, etc. fills the gap or spacing and enhances the dielectric strength and hence increases the corresponding voltage breakdown of the magnet.

External and/or Internal Support Structure for LTS-HTS Amalgam Superconducting Magnet

In many high magnetic field or large superconducting magnets, an external and/or internal non-superconducting support structure is needed to mechanically support the magnet. Superconducting magnets can generate large magnetic forces when energized and as is often the case, the superconducting material is not strong enough to support these electromagnetic forces or loads alone. These forces are also known as Lorentz forces or loads. There are many types of support structures that are necessary depending upon the superconducting magnet and its geometry. For example, superconducting accelerator magnets such as dipoles and quadrupoles are supported with inter-locking collars that surround the periphery of the superconducting coil. In solenoids, the support structures are typically internal bobbins or winding mandrels used in combination with vacuum pressure epoxy impregnation. Alternatively, external support structures such as external bands wrapped around the circumference of the coil or support tubes which encapsulate the superconducting coil. The support structure can also be a combination of both and internal structure and an external structure to the amalgam superconducting magnet. It is important for the support structure material to have both high strength and high modulus. The structure material must have high strength because it must not break due to the high electromagnetic forces experienced during energization. The structure material must also have a high modulus (i.e. stiff), so as not to place too high of a strain on the superconductor itself. Some types of low and high temperature superconductors are very susceptible to Ic degradation at high conductor strain values. LTS materials very susceptible to strain are Nb3Sn, Nb3Al, MgB2, and others. HTS materials such as Bi-2223, Bi-2212, and ReBCO are also very susceptible to Ic degradation at high strain. Having a very stiff structure (i.e. high modulus), reduces the mechanical strain imparted to the superconducting material.

There are many types of materials that are used in external and/or internal support structures. In one embodiment the support structure is metallic. Common metallic materials include: stainless steel, copper alloys, aluminum alloys, titanium, titanium alloys, or other high strength metals. It is important that the metallic used for the external or internal support structure are cryogenically compatible and do not become brittle as the temperature is lowered. It is also important that in the event of quench of the amalgam superconducting magnet that eddy currents induced in the structure.

In one embodiment, the external and/or internal support structure also provides a highly conductive thermal path from the amalgam superconducting magnet to the cooling source, which is typically a mechanical cryogenic refrigerator or cryocooler. In this embodiment, a thermal reservoir of a solid or liquid cryogen may also be the source of cooling. This embodiment is known as a conduction cooled amalgam superconducting magnet. In a conduction cooled amalgam superconducting magnet, it can be advantageous to combine the mechanical support function with the thermal conduction function because it can reduce costs, complexities, and weight of the amalgam superconducting magnet. Materials that are both strong and good thermal conductors are typically used such as copper, copper alloy, aluminum, aluminum alloy, beryllium, aluminum oxide (Al2O3), magnesium, magnesium alloy, combinations thereof, and other thermally conductive high strength materials.

In another embodiment, the support structure is non-metallic. Non-metallic support structures can also be common where excessive mass is a problem such as in space, airborne, or naval platforms. For these types of applications, non-metallic electrically insulating materials such as aramid fiber sold under the brand name Kevlar™ by DuPont, polyamide fiber sold under the brand name Zytel™, carbon fiber, carbon nano-tube, SiC, or other high strength, low material density fibers can be band wrapped around the outer circumference of the superconducting magnet. Another common technique is to use resin epoxy impregnated fibers that have been cured into a stiff structure such as a thick walled tube. The thick walled tube encapsulates the superconducting coil and when the coil is energized, the conductors in the magnet winding are supported or contained by the external support structure rather than by the conductor alone. Common types of external structures include: epoxy impregnated aramid fibers, epoxy impregnated polyamide fibers, epoxy impregnated carbon fiber, epoxy impregnated, carbon nano-tube, fiber reinforced s-glass or e-glass sold under the brand name G-10 or G-11, or thermally injection molded plastics sold under the brand name Ultem™ by General Electric. These external structures can be used in combination with vacuum pressure impregnation of the superconducting coils themselves. It is always important to use a cryogenically compatible epoxy resins that is tolerant of the low temperatures and resistance to cracking upon repeated thermal cycling.

It is recognized that modifications and variations of the disclosed embodiment will be apparent to those of skilled in the art and it is intended that all such modifications and variations be included within the scope of the appended claims.

### DESCRIPTION OF THE EMBODIMENT

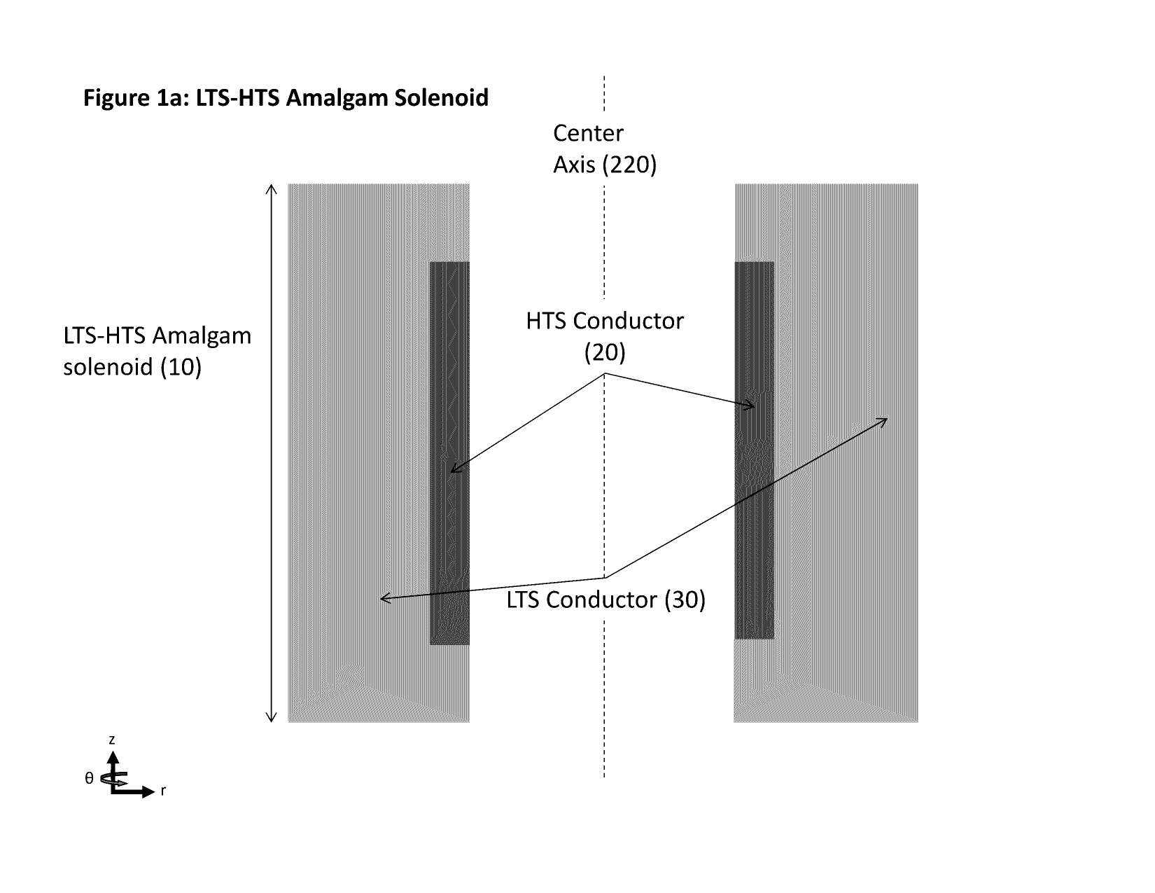

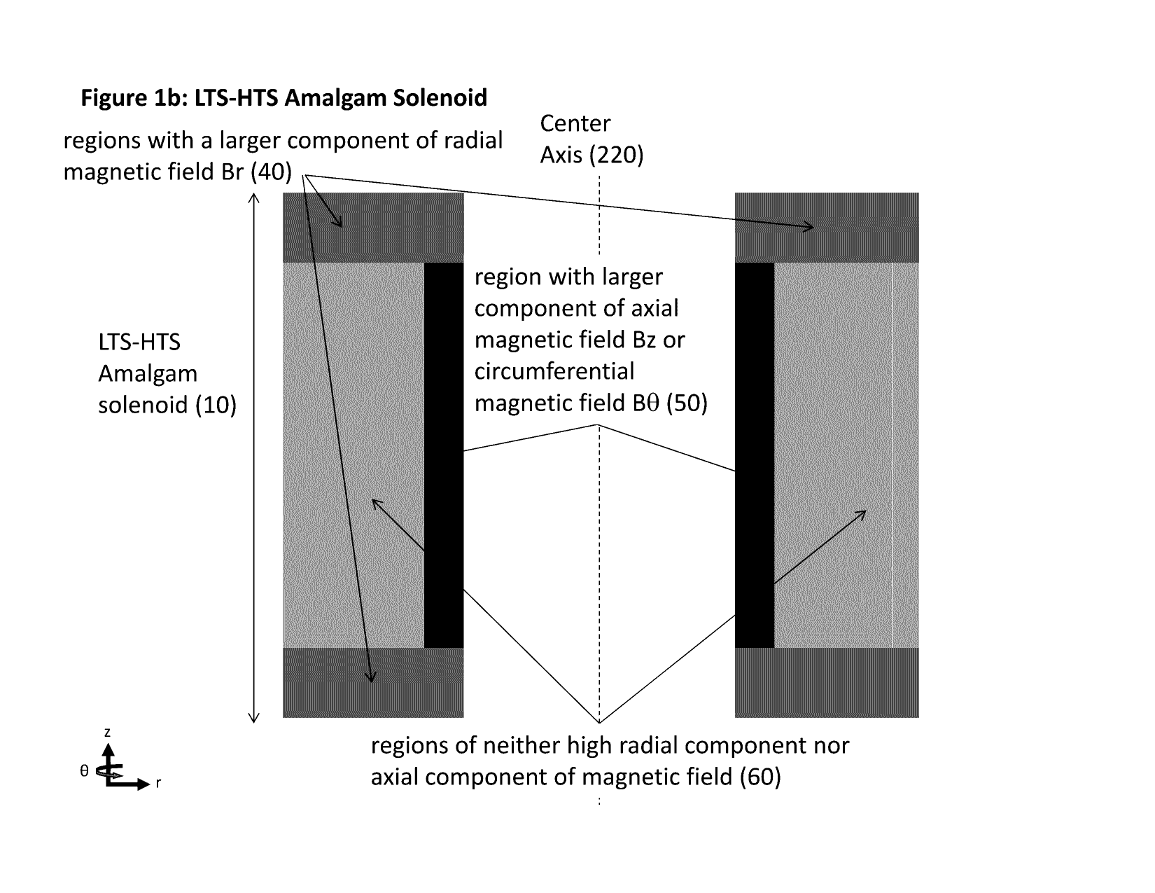

With reference to FIG. 1a, a 2-dimensional cross section of an LTS-HTS amalgam solenoid (10) is shown. The LTS-HTS amalgam solenoid magnet (10) can be fabricated with at least two or more sections in which one or more sections are comprised of HTS conductor (20) and one or more sections are comprised of LTS conductor (30).

With reference to FIG. 1b, a 2-dimensional cross section of an LTS-HTS amalgam solenoid (10) is shown. In the LTS-HTS amalgam solenoid magnet (10), the LTS conductor (30) is used in regions with a larger component of radial magnetic field Br (40). The HTS conductor (20) is used in regions with a larger axial component of magnetic field Bz or circumferential magnetic field Bθ (50). In regions of neither high radial component nor axial component of magnetic field (60), LTS conductor (30) can be used to keep the costs as low as possible.

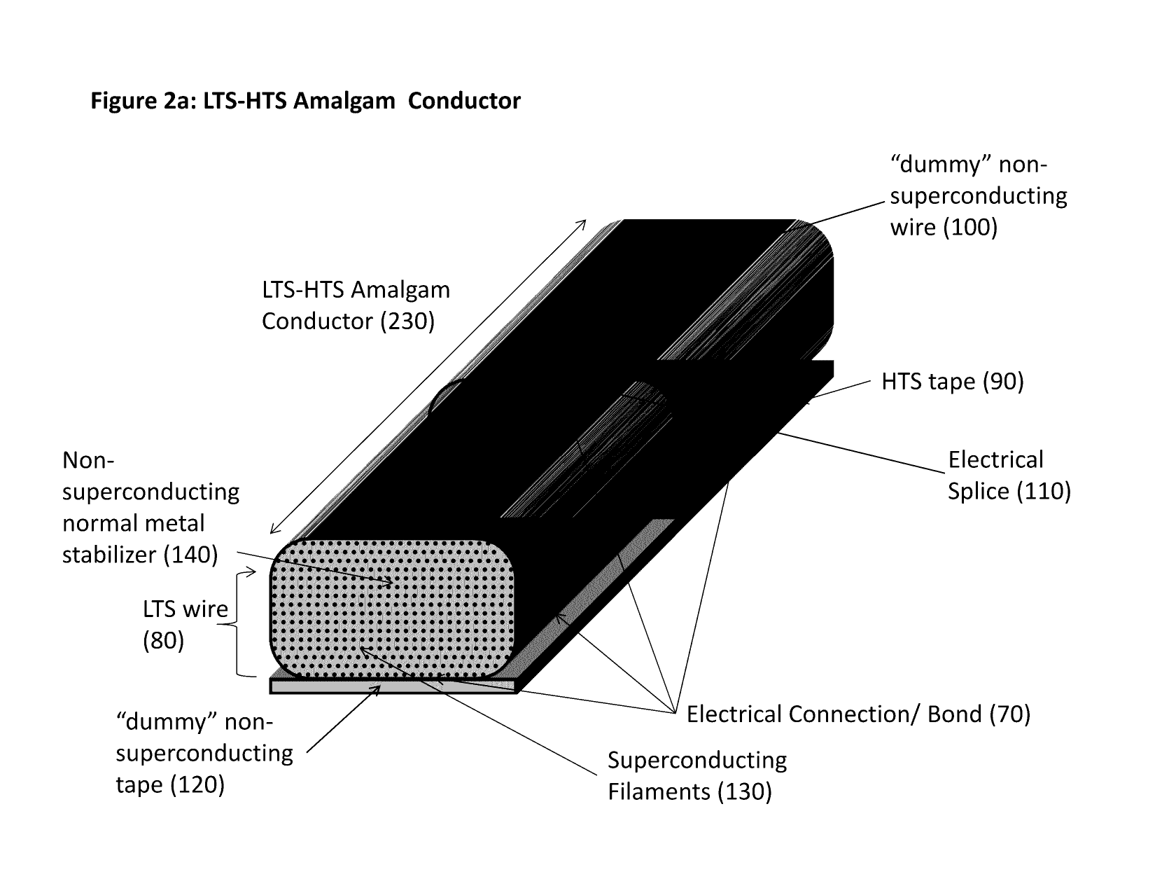

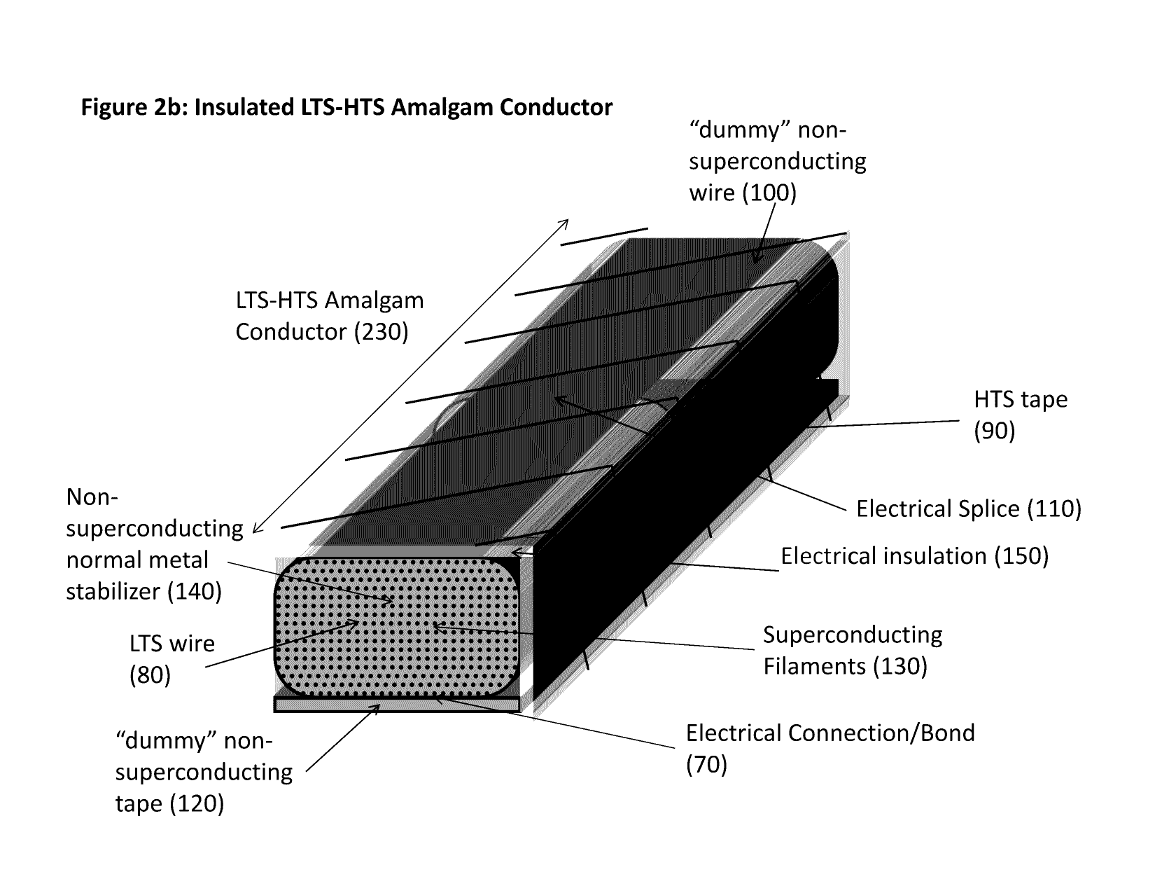

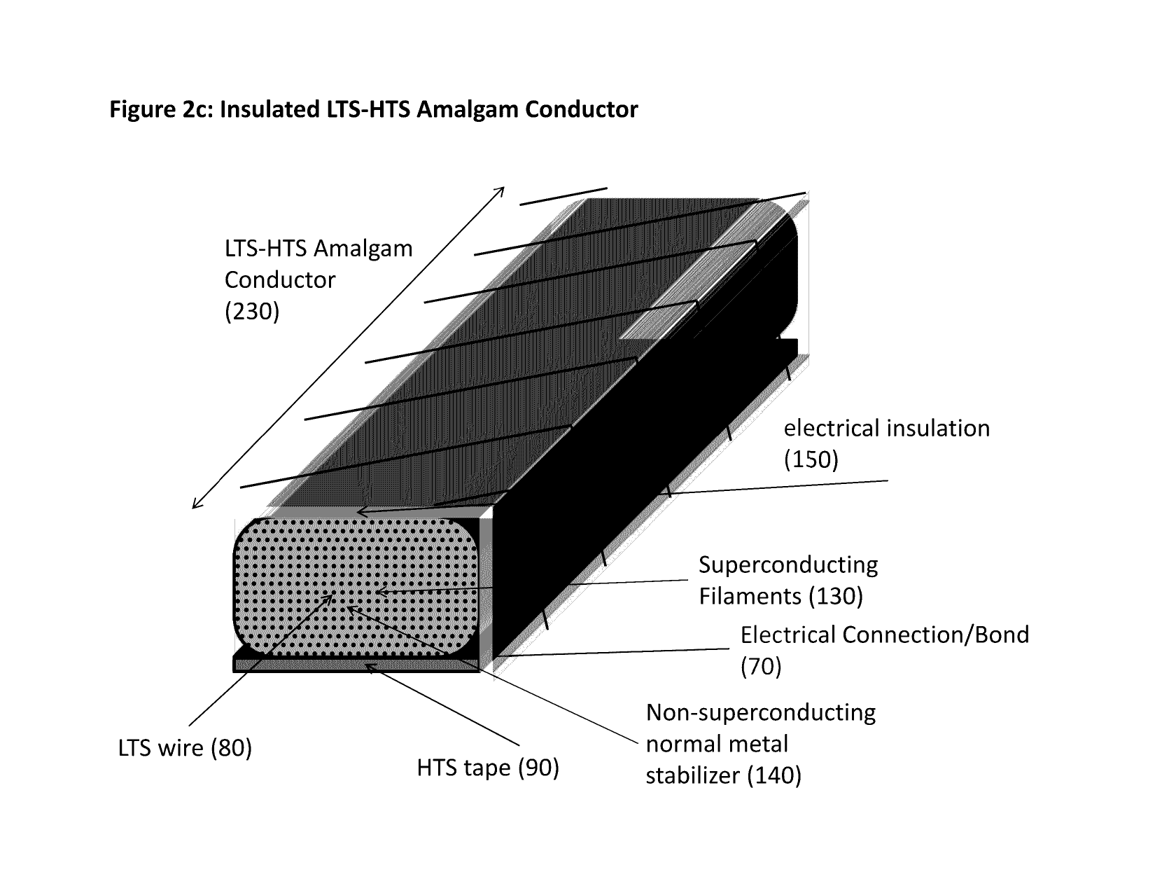

With reference to FIG. 2a, an isometric view of an LTS-HTS amalgam conductor (230) is shown. The LTS-HTS amalgam conductor (230) may be fabricated by electrically connecting/bonding (70) LTS wire (80) to HTS tape (90). The electrical connecting/bonding (70) of the LTS wire (80) to the HTS tape (90) can be performed using techniques such as: solder, cold welds, fusion welds, pressed contacts, conductive epoxies, non-inductive coupling, etc. “Dummy” non-superconducting wire (100) such as copper, silver, aluminum, etc. may be used in some regions by electrically connecting in series the “active” LTS wire (80) to the “dummy” non-superconducting wire (100) via an electrical splice (110) to form a longer length LTS-HTS amalgam conductor (230). In order to keep the cross sectional dimension consistent through the entire LTS-HTS amalgam solenoid magnet (10), “dummy” non-superconducting tape (120) such as Cu, Al, Ag, etc. may replace the “active” HTS tape (90) and be used in the “active” LTS wire (80) piece length. Likewise, in order to keep the cross sectional dimension consistent, “dummy” non-superconducting wire (100) may be used in the “active” HTS tape (90) piece length. The LTS wire (80) can be comprised of multiple very fine superconducting filaments (130) such as Nb—Ti, Nb—Sn, Nb—Al, MgB2, etc. The fine superconducting filaments (130) typically range in size from about 40 micron diameter to sub-micron diameter. Smaller superconducting filament (130) diameters have many benefits including lower hysteric loss when subjected to time varying magnetic fields and currents. Larger superconducting filament (130) diameters typically result in higher critical current densities (Jc). The fine superconducting filaments (130), can be embedded in a non-superconducting normal metal stabilizer (140) such as Cu, Al, Ag, Sn, etc. The non-superconducting normal metal stabilizer (140) serves many useful benefits such as providing electric and thermal stability to the LTS-HTS amalgam conductor (230) and reducing the voltage stress during a quench event.

With respect to FIG. 2b, an insulated isometric view of an LTS-HTS amalgam conductor (230) is shown. Wrapped, extruded, coated, etc. electrical insulation (150) can be included to electrically isolate the LTS-HTS amalgam conductor (230). The amount or thickness of the insulation depends upon the required voltage rating and desired environmental protection.

With reference to FIG. 2c, an insulated isometric view of an LTS-HTS amalgam conductor (230) is shown. The insulated (150) LTS-HTS amalgam conductor (230) can be comprised of all LTS wire (80) and all HTS tape (90).

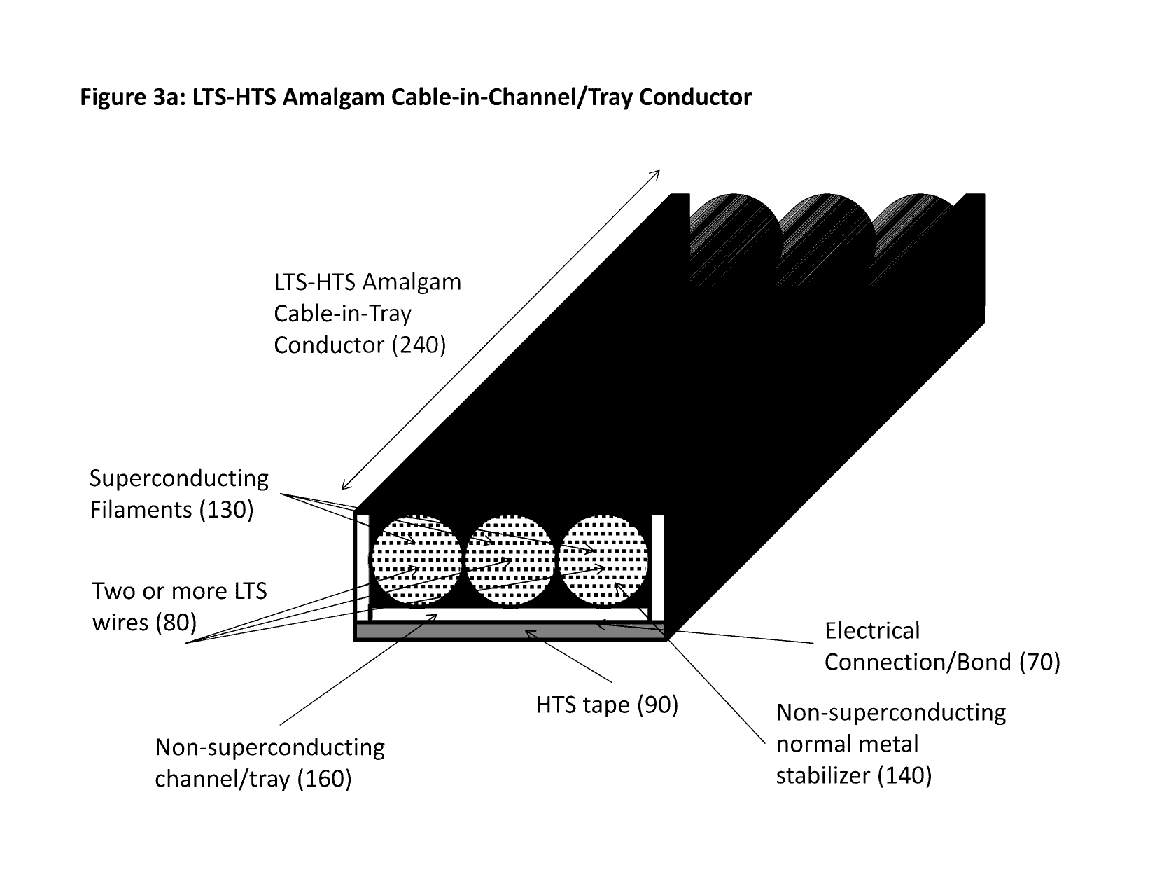

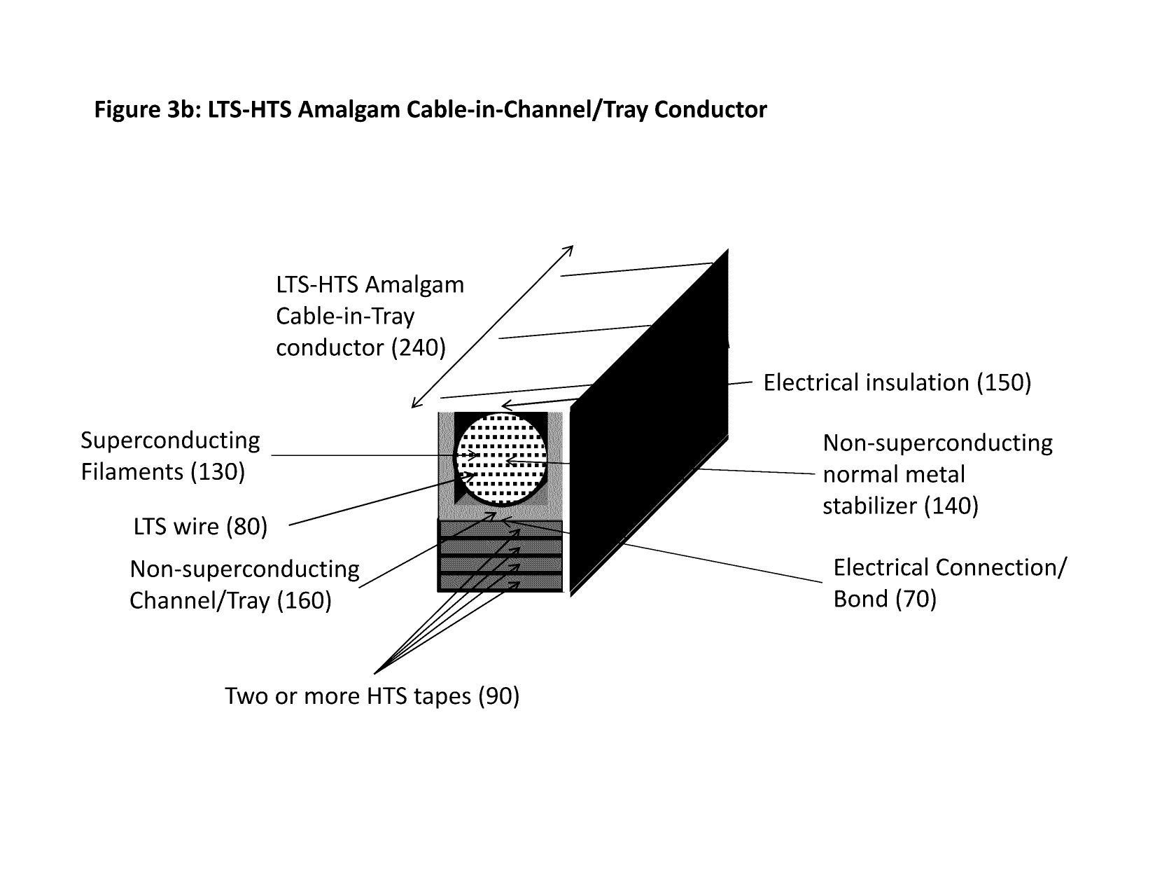

With reference to FIG. 3a, an LTS-HTS amalgam Cable-in-Channel/Tray conductor (240) comprising a plurality of LTS wire(s) (80) and HTS tape(s) (90) can be electrically connected/bonded (70) in parallel. The LTS-HTS amalgam cable-in-tray conductor (240) can be configured with a non-superconducting channel/tray (160) made of Cu, Ag, Al, brass, etc. The LTS wire(s) (80) and HTS tape(s) (90) can be electrically connected/bonded (70) to the non-superconducting channel/tray (160) via solder, cold welds, conductive epoxy, pressed contacts, inductive coupling, etc.

With reference to FIG. 3b, an LTS-HTS amalgam Cable-in-Channel/Tray conductor (240) can be fabricated with at least one or more HTS tapes (90) configured with a non-superconducting channel/tray (160). The LTS wire (80) and HTS tape(s) (90) can be electrically connected/bonded (70) to the non-superconducting channel/tray (160) via solder, cold welds, conductive epoxy, pressed contacts, inductive coupling, etc.

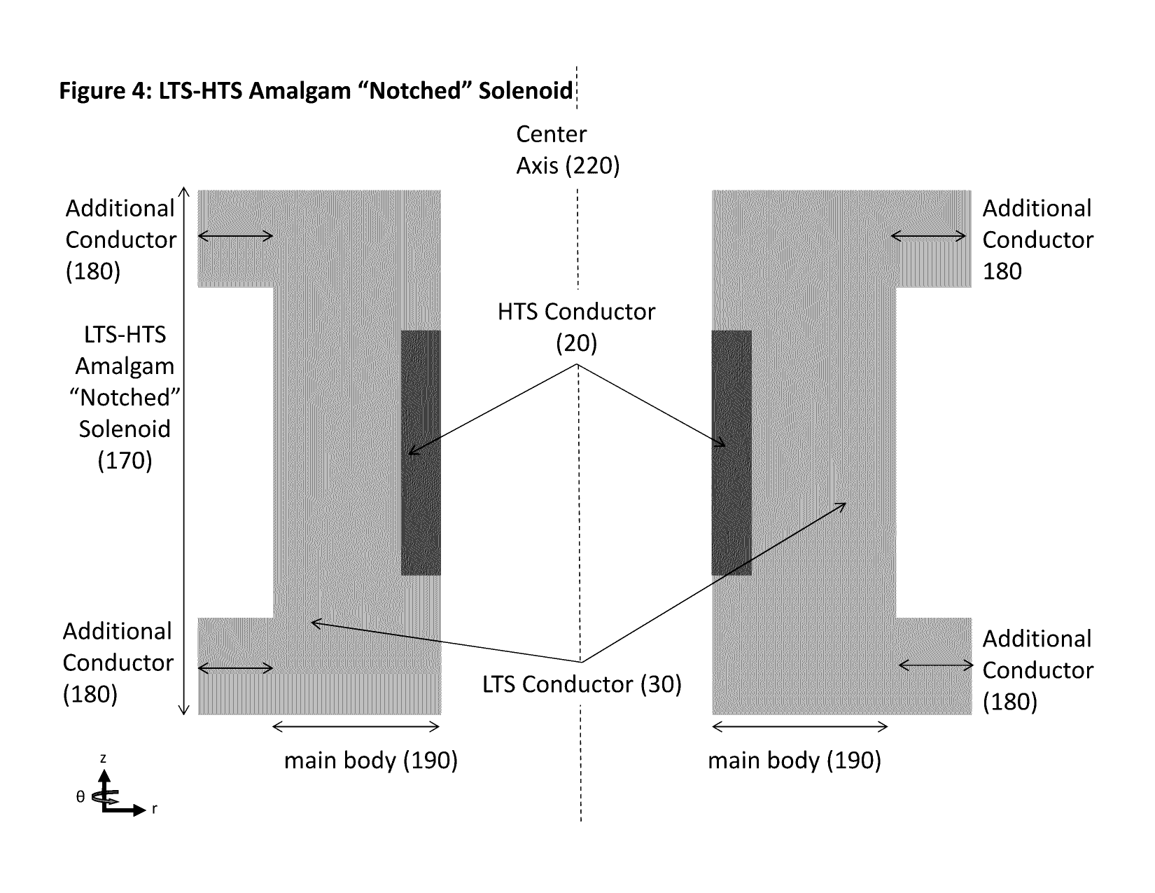

With reference to FIG. 4, a 2-dimensional cross section of an LTS-HTS amalgam “notched” solenoid (170) is shown. The LTS-HTS amalgam “notched” solenoid (170) can be fabricated from a plurality of LTS conductors (30) and HTS conductors (20). Additional conductor windings (180) at the ends of the solenoid (or toroid) magnet (170) are connected to the main body of the LTS-HTS amalgam “notched” solenoid (170). The additional conductor windings can be comprised of HTS conductor (20), LTS conductor (30), or LTS-HTS amalgam conductor (230). The additional conductor windings (180) can be wound in the same direction or in the opposite direction of the windings from the main body (190). The additional conductor windings (180) can be electrically powered with the same power source or from a separate power source from the windings of the main body (190).

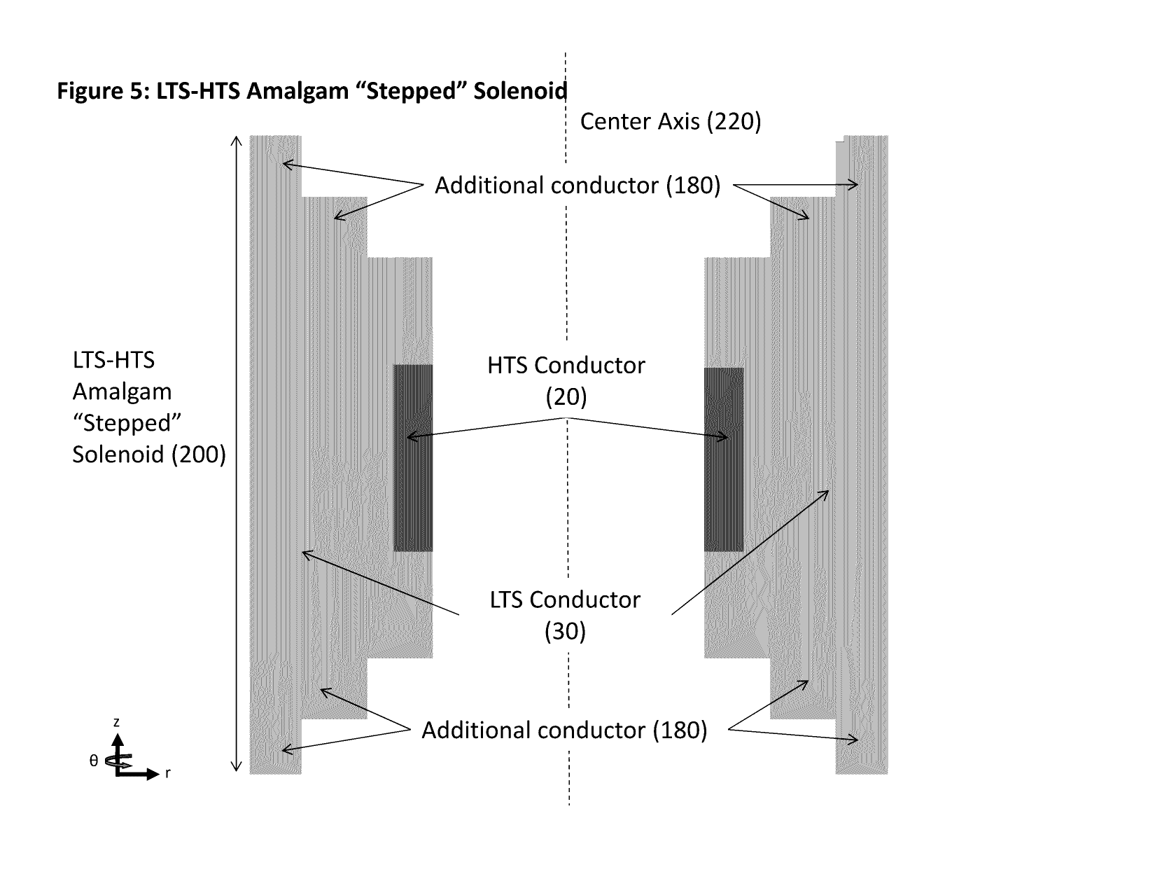

With reference to FIG. 5, a 2-dimensional cross section of an LTS-HTS amalgam “stepped” solenoid (200) is shown. The LTS-HTS amalgam “stepped” solenoid (200) can be fabricated from a plurality of LTS conductors (30) and HTS conductors (20). Additional conductor windings (180) at the ends of the solenoid (or toroid) magnet (200) are separate from the main body (190) of the magnet (200). The additional conductor windings (180) can be comprised of HTS conductor (20), LTS conductor (30), or LTS-HTS amalgam conductor (230). The additional conductor windings (180) allow the shaping of the radial component Br (40) and axial component Bz (50) of the magnetic field. This allows for the optimal use of the isotropic (or weakly anisotropic) LTS conductor (30) and the highly anisotropic HTS conductor (20). At the time of this writing, HTS conductor (20) is far more expensive than LTS conductor (30) so it is more cost effective to minimize the HTS conductor (20) relative to the LTS conductor (30).

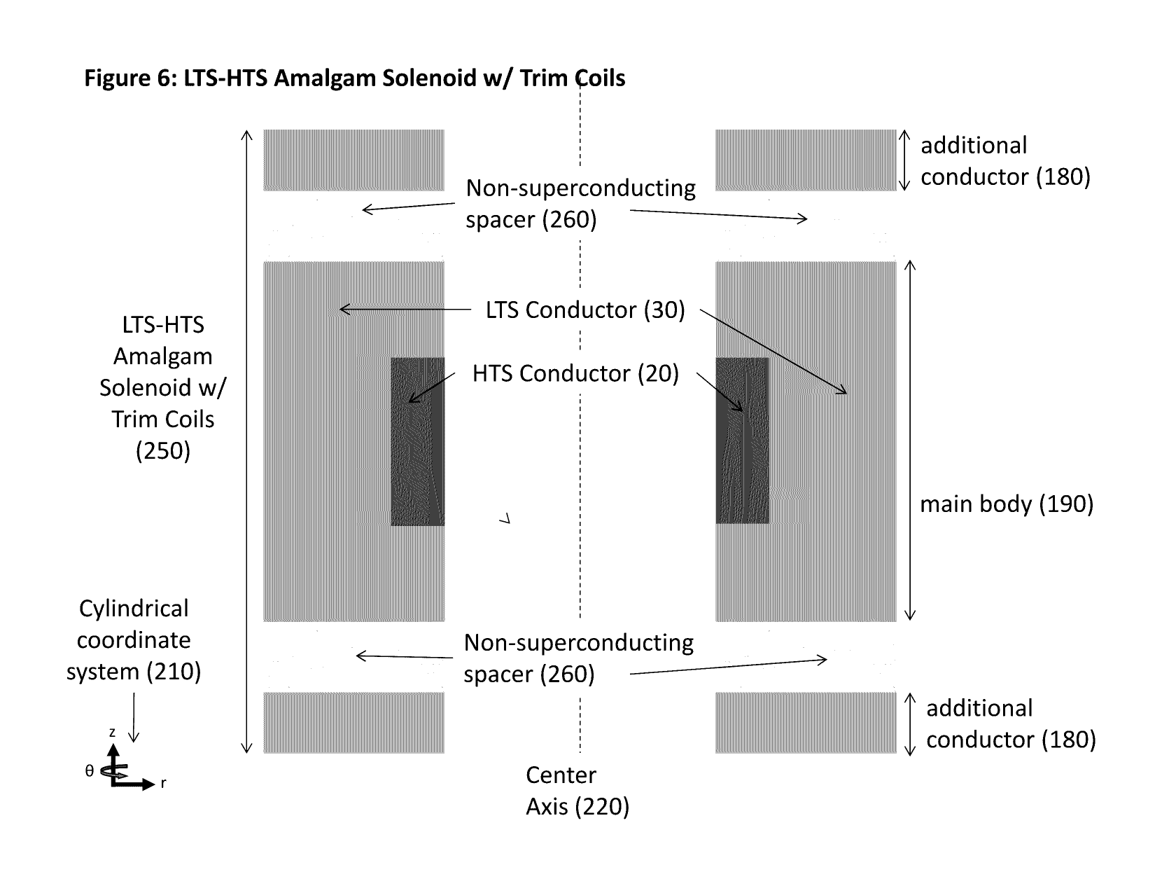

With reference to FIG. 6, a 2-dimensional cross section of an LTS-HTS amalgam solenoid with Trim Coils (250) is shown. The LTS-HTS Amalgam solenoid with Trim Coils magnet (250) can be comprised of LTS conductor (30) and HTS conductor (20). Additional conductor windings (180) at the ends of the solenoid (or toroid) magnet (250) are separate from the main body (190) of the magnet (250). The additional conductor windings (180) can be comprised of HTS conductor (20), LTS conductor (30), or LTS-HTS amalgam conductor (230). The additional conductor windings (180) can be separated from the main body (190) by a non-superconducting spacer (260). The additional conductor windings (180) allow the shaping of the radial component Br (40) and axial component Bz (50) of the magnetic field. This allows for the optimal use of the isotropic (or weakly anisotropic) LTS conductor (30) and the highly anisotropic HTS conductor (20).

With respect to FIGS. 1a, 1b, 4,5, and 6, a cylindrical coordinate system (210) is used in which the axial direction is labeled (z,) the radial direction is labeled (r), and the azimuthal direction is labeled (θ). The solenoid is axisymmetric with respect to the center axis (220).

1. An amalgam superconducting magnet comprising:
at least one or more low temperature superconductors;
at least one or more high temperature superconductors;
wherein the low temperature superconductors and the high temperature superconductors have been wound into an amalgam superconducting magnet.

2. The amalgam superconductor magnet of claim 1, wherein the low temperature superconductor is a round or nearly round wire or multiple wires and the high temperature superconductor is a flat or nearly flat tape or multiple tapes.

3. The amalgam superconductor magnet of claim 1, wherein both the low temperature superconductor and the high temperature superconductor is a round or nearly round wire or multiple wires.

4. The amalgam superconductor magnet of claim 1, wherein both the low temperature superconductor and the high temperature superconductor are rectangular conductor, square conductor, flat or nearly flat tapes or multiple tapes.

5. The amalgam superconductor magnet of claim 1, wherein the amalgam superconducting magnet is comprised of a plurality of single pancake coils, double pancake coils, or continuously wound pancake coils.

6. The amalgam superconductor magnet of claim 1, wherein the amalgam superconducting coil is a layer wound, spiral wound, or screw wound solenoid or toroid coil.

7. The amalgam superconducting magnet of claim 1, wherein the amalgam superconducting magnet is a notched solenoid coil, a notched toroid coil, or a notched racetrack coil.

8. The amalgam superconductor magnet of claim 1, wherein the amalgam superconducting magnet is a Helmholtz coil, a dipole coil, a quadrupole coil, a sextupole coil, a racetrack coil, a saddle coil, or other coil configuration.

9. The amalgam superconducting magnet of claim 2, wherein the high temperature superconducting tape or multiple tapes are coated on both sides to increase its current carrying capacity.

10. The amalgam superconductor magnet of claim 1, wherein the high temperature superconductor is: Re—Ba—Cu—O, Y—Ba—Cu—O, Bi—Sr—Ca—Cu—O, Bi—Pb—Sr—Ca—Cu—O, Tl—Ba—Ca—Cu—O, Hg—Ba—Ca—Cu—O, iron-pnictides, iron-chalcogenides, or chemically doped alloys and mixtures thereof.

11. The amalgam superconductor magnet of claim 1, wherein the low temperature superconductor is: Nb, Va, Pb, NbTi, Nb₃Sn, (NbTi)₃Sn, Nb₃Al, or Mg—B, MgB₂, or chemically doped alloys and mixtures thereof.

12. The amalgam superconductor magnet of claim 2, wherein a length of the low temperature superconducting wire or multiple wires is electrically connected together in series with a separate length of the high temperature superconducting tape or multiple tapes to form a longer combined length of amalgam superconductor.

13. The amalgam superconductor magnet of claim 2, wherein a length of low temperature superconducting wire or wires is electrically connected in series with another length of low temperature superconducting wire or wires to form a continuous superconductor persistent current joint.

14. The amalgam superconductor magnet of claim 2, wherein a length of high temperature superconductor is electrically connected in series with another length of low temperature superconducting wire or wires to form a continuous superconductor persistent current joint.

15. The amalgam superconductor magnet of claim 2, wherein a persistent current joint is made by cold welding, soldering, electro-discharge welding, or other electrical connections methods.

16. The amalgam superconductor magnet of claim 2, wherein the low temperature superconducting wire or multiple wires is electrically connected in parallel with the high temperature superconducting tape or multiple tapes to form a single continuous amalgam superconductor.

17. The amalgam superconducting magnet of claim 2, wherein the high temperature superconducting tape or multiple tapes is used in the regions of higher magnetic fields and the low temperature superconducting wire or multiple wires is used in regions of lower magnetic field.

18. The amalgam superconducting magnet of claim 2, wherein the high temperature superconducting tape or multiple tapes is used in the regions of lower perpendicular, transverse, or radial magnetic fields and the low temperature superconducting wire or multiple wires is used in regions of higher perpendicular, transverse, or radial magnetic field.

19. The amalgam superconducting magnet of claim 2, wherein the high temperature superconducting tape or multiple tapes is used in the regions of higher magnetic fields that impinge parallel to either the short axis or longitudinal axis of the high temperature superconducting tape or multiple tapes.

20. The amalgam superconducting magnet of claim 1, wherein the amalgam superconducting magnet is cooled by submersion into a cryogenic fluid or solid cryogen.

21. The amalgam superconducting magnet of claim 1, wherein the amalgam superconducting magnet is cooled by thermal conduction.

22. The amalgam superconducting magnet of claim 1, wherein the amalgam superconducting magnet is cooled by convection using a force flow of a cryogenic fluid.

23. The amalgam superconducting magnet of claim 1, wherein the amalgam superconducting magnet is an electromagnet including the use of magnetic permeable material such as iron, nickel, cobalt, steel, alloys thereof, or other magnetic permeable materials.

24. The amalgam superconducting magnet of claim 1, wherein the amalgam superconducting magnet is used in a magnetic resonance imaging or nuclear magnetic resonance device.

25. The amalgam superconducting magnet of claim 1, wherein the additional coils are included in specified regions to provide active cancellation of stray magnetic fields and thereby reduce the magnetic signature of the device.

26. The amalgam superconducting magnet of claim 1, wherein additional superconductor windings are included at the ends of the coil to form a notched superconducting amalgam magnet.

27. The amalgam superconducting magnet of claim 2, wherein the LTS wire or multiple wires and HTS tape or multiple tapes is electrically insulated using the following techniques: spiral wrapping with overlap, butt-wrapping with no overlap, co-winding, covering with heat shrinkable tubing, extrusion, spray coating, dip coating, plasma flame spray coating, combinations thereof, or other insulating methods.

28. The amalgam superconducting magnet of claim 2, wherein the LTS wire or multiple wires and HTS tape or multiple tapes is electrically insulated with poly(4,4′-oxydiphenylene-pyromellitimide), polytetrafluoroethylene (PTFE), s-glass, e-glass, epoxy, meta-aramid, polyvinyl form resin, polypropylene (PPLP), cellulose, polyolefin, polyvinyl acetyl resin, or other insulating materials.

29. The amalgam superconducting magnet of claim 1, further comprising an external and/or internal non-superconducting structure that is use to support or contain the electromagnetic forces of the amalgam superconducting magnet.

30. The amalgam superconducting magnet of claim 27, wherein the external and/or internal structure that is used to support or contain the electromagnetic forces of the amalgam superconducting magnet and the support structure is non-metallic comprised of aramid fiber, epoxy impregnated aramid fiber, carbon fiber, epoxy impregnated carbon fiber, carbon-nano-tube, epoxy impregnated carbon-nano-tube, epoxy impregnated s-glass, epoxy impregnated e-glass, fiber reinforced plastic, thermo-injected molded plastic, or other non-metallic insulating structural materials.

31. The amalgam superconducting magnet of claim 27, wherein the external and/or internal structure that is used to support or contain the electromagnetic forces of the amalgam superconducting magnet and the support structure is metallic comprised of stainless, steel, copper, copper alloy, aluminum, aluminum alloy, titanium, titanium alloy, or other high strength cryogenically compatible metals.

32. An amalgam superconducting magnet comprising:
at least one or more low temperature superconductors;
at least one or more high temperature superconductors;
wherein the low temperature superconductor and the high temperature superconductor are electrically connected to form an amalgam superconducting magnet.

33. The amalgam superconductor magnet of claim 32, wherein the low temperature superconductor is a round or nearly round wire or multiple wires and the high temperature superconductor is a flat or nearly flat tape or multiple tapes.

34. The amalgam superconductor magnet of claim 32, wherein both the low temperature superconductor and the high temperature superconductor are round or nearly round wire or multiple wires.

35. The amalgam superconductor magnet of claim 32, wherein both the low temperature superconductor and the high temperature superconductor are flat or nearly flat tapes or multiple tapes.

36. The amalgam superconducting magnet of claim 32, wherein the low temperature superconductor and the high temperature superconductor are electrically connected using solder, welding, pressed contacts, or other electrical connections methods.

37. The amalgam superconducting magnet of claim 33, wherein the high temperature superconducting tape or multiple tapes are coated on both sides to increase its current carrying capacity.

38. The amalgam superconductor magnet of claim 32, wherein the amalgam superconducting magnet is comprised of a plurality of single pancake coils, double pancake coils, or continuously wound pancake coils.

39. The amalgam superconductor magnet of claim 32, wherein the amalgam superconducting coil is a layer wound, spiral wound, or screw wound solenoid or toroid coil.

40. The amalgam superconducting magnet of claim 32, wherein the amalgam superconducting magnet is a notched solenoid, notched toroid, or notched racetrack coil.

41. The amalgam superconductor magnet of claim 32, wherein the amalgam superconducting magnet is a Helmholtz coil, a dipole coil, a quadrupole coil, a sextupole coil, a racetrack coil, a saddle coil, or other coil configuration.

42. The amalgam superconductor magnet of claim 32, wherein the high temperature superconductor is comprised of: Re—Ba—Cu—O, Y—Ba—Cu—O, Bi—Sr—Ca—Cu—O, Bi—Pb—Sr—Ca—Cu—O, Tl—Ba—Ca—Cu—O, Hg—Ba—Ca—Cu—O, iron-pnictides, iron-chalcogenides, or chemically doped alloys and mixtures thereof.

43. The amalgam superconductor magnet of claim 32, wherein the low temperature superconductor is comprised of: Nb, Va, Pb, NbTi, Nb₃Sn, (NbTi)₃Sn, Nb₃Al, or Mg—B, or MgB₂, or chemically doped alloys and mixtures thereof.

44. The amalgam superconductor magnet of claim 32, wherein a length of the low temperature superconductor is electrically connected together in series with a separate length of the high temperature superconductor to form a longer combined length of amalgam superconductor.

45. The amalgam superconductor magnet of claim 32, wherein the low temperature superconductor is electrically connected in parallel with the high temperature superconductor to form a single continuous amalgam superconductor.

46. The amalgam superconductor magnet of claim 32, wherein the low temperature superconductor is electrically connected in parallel with the high temperature superconductor by solder, welding, pressed contacts, or other electrical connection methods.

47. The amalgam superconductor magnet of claim 32, wherein the length of low temperature superconductor is electrically connected in series with another length of low temperature superconductor to form a continuous superconductor persistent current joint.

48. The amalgam superconductor magnet of claim 32, wherein a length of high temperature superconductor is electrically connected in series with another length of high temperature superconductor to form a continuous superconductor persistent current joint.

49. The amalgam superconductor magnet of claim 48, wherein the continuous superconductor persistent current joint is made by cold welding, soldering, electro-discharge welding, or other electrical connections methods.

50. The amalgam superconducting magnet of claim 32, wherein the high temperature superconductor is used in the regions of higher magnetic fields and the low temperature superconductor is used in regions of lower magnetic field.

51. The amalgam superconducting magnet of claim 32, wherein the high temperature superconductor is used in the regions of lower perpendicular, transverse, or radial magnetic fields and the low temperature superconductor is used in regions of higher perpendicular or radial magnetic field.

52. The amalgam superconducting magnet of claim 32, wherein the high temperature superconductor is used in the regions of higher magnetic fields that impinge parallel to either the short axis or longitudinal axis of the high temperature superconductor.

53. The amalgam superconducting magnet of claim 32, wherein the amalgam superconducting magnet is cooled by submersion into a cryogenic fluid or solid cryogen.

54. The amalgam superconducting magnet of claim 32, wherein the amalgam superconducting magnet is cooled by thermal conduction.

55. The amalgam superconducting magnet of claim 32, wherein the amalgam superconducting magnet is cooled by convection using a force flow of a cryogenic fluid.

56. The amalgam superconducting magnet of claim 32, wherein the amalgam superconducting magnet is an electromagnet including the use of magnetic permeable material such as iron, nickel, cobalt, or alloys thereof.

57. The amalgam superconducting magnet of claim 32, wherein the amalgam superconducting magnet is used in a magnetic resonance imaging or nuclear magnetic resonance device.

58. The amalgam superconducting magnet of claim 32, wherein the additional coils are included in specified regions to provide active cancellation of stray magnetic fields and thereby reduce the magnetic signature of the device.

59. The amalgam superconducting magnet of claim 32, wherein additional superconductor windings are included at the ends of the coil to form a notched superconducting amalgam magnet.

60. The amalgam superconducting magnet of claim 32, wherein the low temperature superconductor and high temperature superconductor are electrically insulated using one or more of the following techniques: spiral wrapping with overlap, butt-wrapping with no overlap, co-winding, covering with heat shrinkable tubing, extrusion, spray coating, dip coating, plasma flame spray coating, combinations thereof, or other insulating methods.

61. The amalgam superconducting magnet of claim 32, wherein the low temperature superconductor and the high temperature superconductor are electrically insulated with one or more of the following: poly(4,4′-oxydiphenylene-pyromellitimide), polytetrafluoroethylene (PTFE), s-glass, e-glass, epoxy, meta-aramid, polyvinyl form resin, polypropylene (PPLP), cellulose, polyolefin, polyvinyl acetyl resin, or other insulating materials.

62. The amalgam superconducting magnet of claim 32, further comprising an internal and/or external non-superconducting structure that is use to support or contain the electromagnetic forces of the amalgam superconducting magnet.

63. The amalgam superconducting magnet of claim 62, wherein the internal and/or external structure that is used to support or contain the electromagnetic forces of the amalgam superconducting magnet is non-metallic and comprised of aramid fiber, epoxy impregnated aramid fiber, carbon fiber, epoxy impregnated carbon fiber, carbon-nano-tube, epoxy impregnated carbon-nano-tube, epoxy impregnated s-glass, epoxy impregnated e-glass, fiber reinforced plastic, thermo-injected molded plastic, or other non-metallic structural materials.

64. The amalgam superconducting magnet of claim 62, wherein the internal and/or external structure that is used to support the electromagnetic forces when the amalgam superconducting magnet is energized is metallic and comprised of stainless, steel, copper, copper alloy, aluminum, aluminum alloy, titanium, titanium alloy, or other high strength cryogenically compatible metals.

65. An amalgam superconducting magnet comprising:
At least one or more low temperature superconductors;
At least one or more high temperature superconductors; and
a non-superconducting spacer;
wherein the low temperature superconductor and the high temperature superconductor have been wound into an amalgam superconducting magnet.

66. The amalgam superconductor magnet of claim 65, wherein the low temperature superconductor is a round or nearly round wire or multiple wires and the high temperature superconductor is a flat tape or multiple tapes.

67. The amalgam superconductor magnet of claim 65, wherein both the low temperature superconductor and the high temperature superconductor are round or nearly round wire or multiple wires.

68. The amalgam superconductor magnet of claim 65, wherein both the low temperature superconductor and the high temperature superconductor are flat or nearly flat tapes or multiple tapes.

69. The amalgam superconducting magnet of claim 65, wherein the low temperature superconductor and the high temperature superconductor are electrically connected using solder, welding, pressed contacts, or other electrical connections methods.

70. The amalgam superconducting magnet of claim 66, wherein the high temperature superconducting tape or tapes are coated on both sides to increase its current carrying capacity.

71. The amalgam superconductor magnet of claim 65, wherein the amalgam superconducting magnet is comprised of a plurality of single pancake coils, double pancake coils, or continuously wound pancake coils.

72. The amalgam superconductor magnet of claim 65, wherein the amalgam superconducting coil is a layer, spiral, or screw wound solenoid or toroid coil.

73. The amalgam superconductor magnet of claim 65, wherein the amalgam superconducting magnet is a Helmholtz coil, a dipole coil, a quadrupole coil, a sextupole coil, a racetrack coil, a saddle coil, or other coil configuration.

74. The amalgam superconductor magnet of claim 65, wherein the high temperature superconductor is comprised of: Re—Ba—Cu—O, Y—Ba—Cu—O, Bi—Sr—Ca—Cu—O, Bi—Pb—Sr—Ca—Cu—O, Tl—Ba—Ca—Cu—O, Hg—Ba—Ca—Cu—O, iron-pnictides, iron-chalcogenides, or chemically doped alloys and mixtures thereof.

75. The amalgam superconductor magnet of claim 65, wherein the low temperature superconductor is comprised of: Nb, Va, Pb, NbTi, Nb₃Sn, (NbTi)₃Sn, Nb₃Al, or Mg—B, or MgB₂, or chemically doped alloys and mixtures thereof.

76. The amalgam superconductor magnet of claim 65, wherein a length of the low temperature superconductor is electrically connected together in series with a separate length of the high temperature superconductor to form a longer combined length of amalgam superconductor.

77. The amalgam superconductor magnet of claim 65, wherein the low temperature superconductor is electrically connected in parallel with the high temperature superconductor to form a single continuous amalgam superconductor.

78. The amalgam superconductor magnet of claim 65, wherein the low temperature superconductor is electrically connected in parallel with the high temperature superconductor by solder, welding, pressed contacts, or other electrical connection methods.

79. The amalgam superconductor magnet of claim 65, wherein the length of low temperature superconductor is electrically connected in series with another length of low temperature superconductor to form a continuous superconductor persistent current joint.

80. The amalgam superconductor magnet of claim 65, wherein the length of high temperature superconductor is electrically connected in series with another length of high temperature superconductor to form a continuous superconductor persistent current joint.

81. The amalgam superconductor magnet of claim 65, wherein the continuous superconductor persistent current joint is made by cold welding, soldering, electro-discharge welding, or other electrical connections methods.

82. The amalgam superconductor magnet of claim 65, wherein the high temperature superconductor is used in the regions of higher magnetic fields and the low temperature superconductor is used in regions of lower magnetic field.

83. The amalgam superconductor magnet of claim 65, wherein the high temperature superconductor is used in the regions of lower perpendicular, transverse, or radial magnetic fields and the low temperature superconductor is used in regions of higher perpendicular or radial magnetic field.

84. The amalgam superconductor magnet of claim 66, wherein the high temperature superconductor is used in the regions of higher magnetic fields that impinge parallel to either the short axis or longitudinal axis of the high temperature superconducting tape or multiple tapes.

85. The amalgam superconductor magnet of claim 65, wherein the amalgam superconducting magnet is cooled by submersion into a cryogenic fluid or solid cryogen.

86. The amalgam superconductor magnet of claim 65, wherein the amalgam superconducting magnet is cooled by thermal conduction.

87. The amalgam superconductor magnet of claim 65, wherein the amalgam superconducting magnet is cooled by convection using a force flow of a cryogenic fluid.

88. The amalgam superconductor magnet of claim 65, wherein the amalgam superconducting magnet is an electromagnet including the use of magnetic permeable material such as iron, nickel, cobalt, steel, alloys thereof, or other magnetic permeable material.

89. The amalgam superconductor magnet of claim 65, wherein the amalgam superconducting magnet is used in a magnetic resonance imaging or nuclear magnetic resonance device.

90. The amalgam superconductor magnet of claim 65, wherein the low temperature superconductors and high temperature superconductors are electrically insulated using one or more of the following techniques: spiral wrapping with overlap, butt-wrapping with no overlap, co-winding, covering with heat shrinkable tubing, extrusion, spray coating, dip coating, plasma flame spray coating, combinations thereof, or other insulating methods.

91. The amalgam superconductor magnet of claim 65, wherein the low temperature superconductors and high temperature superconductors are electrically insulated with poly(4,4′-oxydiphenylene-pyromellitimide), polytetrafluoroethylene (PTFE), s-glass, e-glass, epoxy, meta-aramid, polyvinyl form resin, polypropylene (PPLP), cellulose, polyolefin, polyvinyl acetyl resin, or other insulating materials.

92. The amalgam superconductor magnet of claim 65, further comprising an internal and/or external non-superconducting structure that is use to support or contain the electromagnetic forces of the amalgam superconducting magnet.

93. The amalgam superconductor magnet of claim 92, wherein the internal and/or external structure is non-metallic and comprised of aramid fiber, epoxy impregnated aramid fiber, carbon fiber, epoxy impregnated carbon fiber, carbon-nano-tube, epoxy impregnated carbon-nano-tube, epoxy impregnated s-glass, epoxy impregnated e-glass, fiber reinforced plastic, thermo-injected molded plastic, or other non-metallic structural materials.

94. The amalgam superconductor magnet of claim 92, wherein the internal and/or external structure is metallic and comprised of stainless steel, low carbon steel, copper, copper alloy, aluminum, aluminum alloy, titanium, titanium alloy, or other high strength cryogenically compatible metals.

95. The amalgam superconductor magnet of claim 65, further comprising additional windings of low temperature superconductors, high temperature superconductors, or an LTS-HTS amalgam superconductors separated by the non-superconducting spacer from the main body of the amalgam superconductor magnet.

96. The amalgam superconductor magnet of claim 95, wherein the additional windings of low temperature superconductor, high temperature superconductor, or an LTS-HTS amalgam superconductor are placed at the end sections of said amalgam superconductor magnet and said additional windings are separated by the non-superconducting spacer from the main body of said amalgam superconductor magnet to provide active cancellation of stray magnetic fields and thereby reduce the magnetic signature of the amalgam superconductor magnet.

97. The amalgam superconductor magnet of claim 95, wherein the additional windings of low temperature superconductor, high temperature superconductor, or LTS-HTS amalgam superconductor are placed at the end sections of said amalgam superconductor magnet and said additional windings are separated by the non-superconducting spacer from the main body of said amalgam superconductor magnet and said additional windings are independently powered from separate sources.

98. The amalgam superconductor magnet of claim 95, wherein the additional windings of low temperature superconductor, high temperature superconductor, or LTS-HTS amalgam superconductor are placed at the end sections of said superconductor amalgam magnet and said additional windings are separated by the non-superconducting spacer from the main body of said amalgam superconductor magnet and said additional windings are electrically connected in series with said amalgam superconductor magnet and powered from the same power source.

99. The amalgam superconductor magnet of claim 95, wherein the additional windings of low temperature superconductor, high temperature superconductor, or LTS-HTS amalgam superconductor are placed at the end sections of said amalgam superconductor magnet and said additional windings are separated by the non-superconducting spacer from the main body of said amalgam superconductor magnet and said additional windings are wound in the opposite direction as said amalgam superconductor magnet and electrically connected in series and powered from the same power source.

100. The amalgam superconductor magnet of claim 95, wherein the additional windings of low temperature superconductor, high temperature superconductor, or LTS-HTS amalgam superconductor are placed at the end sections of said amalgam superconductor magnet and said additional windings are separated by the non-superconducting spacer from the main body of said amalgam superconductor magnet and said additional windings are wound in the same direction as said magnet and electrically connected in series with said magnet and powered from the same power source of said magnet.

101. The amalgam superconducting magnet of claim 95, wherein the additional windings are included at the ends of the coil to form a notched superconducting amalgam magnet.
